(19) United States
(12) Patent Application Publication
(10) Pub. No.: US 2026/0288516 A1
(43) Pub. Date: Sep. 24, 2026

(54) HIERARCHICAL VERIFICATION PROPAGATION IN DISTRIBUTED TASK DELEGATION SYSTEMS

(71) Applicant: Michael Duane Cooper, Eagle, ID (US)

(72) Inventor: Michael Duane Cooper, Eagle, ID (US)

(21) Appl. No.: 19/564,768

(22) Filed: Mar. 12, 2026

(51) Int. Cl. G06F 9/48

(52) U.S. Cl. CPC G06F 9/4881; G06F 2209/481

(57) ABSTRACT

A system and method for hierarchical verification propagation in distributed task delegation systems. Computational entities—including autonomous software agents, microservices, robotic systems, and human-supervised processes—delegate sub-tasks through tree-structured task specification record hierarchies. When a child task specification record completes verification, a sibling-complete aggregation algorithm acquires a row-level exclusion lock on the parent record, queries all sibling records, determines whether all have reached terminal verification states, computes an aggregate outcome, atomically transitions the parent through defined state machine states, and appends cryptographically hash-chained audit entries within the same database transaction. Upon committing, a deferred propagation job is enqueued to a durable message queue for the next ancestor level, enabling bounded, durable recursive propagation through delegation chains of configurable maximum depth. Circular delegation is prevented through recursive ancestor traversal at chain creation time.

### CROSS-REFERENCE TO RELATED APPLICATIONS

This application claims the benefit of U.S. Provisional Application No. 63/999,660, filed Mar. 8, 2026, under 35 U.S.C. § 119(e), which is hereby incorporated by reference in its entirety.

This application is related to the following co-pending U.S. Provisional Applications by the same applicant, each of which is hereby incorporated by reference in its entirety:
U.S. Provisional Application No. 63/999,669, filed Mar. 8, 2026, entitled “System and Method for Application-Layer Tamper-Evident Audit Chain Maintenance with Per-Record Chain Isolation, Transactional State-Change Atomicity, and Regulatory Compliance Integration,” which describes the tamper-evident audit chain architecture into which the verification state transitions of the present invention are recorded.
U.S. Provisional Application No. 63/999,674, filed Mar. 8, 2026, entitled “System and Method for Automated Compliance Verification of Task Attestations Using Schema-Driven Structural Validation and Criterion-Specific Tolerance Comparison,” which describes the two-phase verification engine that produces the verification outcomes propagated by the hierarchical system of the present invention.
U.S. Provisional Application No. 63/999,676, filed Mar. 8, 2026, entitled “Method and System for Automated Dispute Resolution in Agent Operations via Criterion-Specific Tolerance Expansion and Re-Verification,” which describes a dispute resolution mechanism that may alter verification outcomes within the delegation hierarchies managed by the present invention.
U.S. Provisional Application No. 64/003,331, entitled “System and Method for Federated Accountability Networks in Multi-Platform Agentic Computing Environments,” which describes a federated network architecture through which the hierarchical verification system of the present invention may operate across organizational boundaries.
U.S. Provisional Application No. 64/003,332, entitled “System and Method for Settlement Signal Gating in Automated Agent Transaction Processing,” which describes the settlement signaling mechanisms triggered by the verification outcomes produced by the hierarchical system of the present invention.

### STATEMENT REGARDING FEDERALLY SPONSORED RESEARCH OR DEVELOPMENT

Not Applicable.

### BACKGROUND OF THE INVENTION

### Field of the Invention

The present invention relates generally to distributed computing systems, and more particularly to systems and methods for maintaining data integrity during hierarchical task verification in distributed workflow environments. The invention addresses problems of concurrent state management, cryptographic audit trail integrity, and recursive verification outcome propagation in systems where computational entities—including but not limited to autonomous software agents, microservices, robotic process automation (RPA) systems, IoT device controllers, enterprise workflow participants, or human-supervised computational processes—delegate tasks through hierarchical chains of responsibility. The invention is agnostic to the nature of the performing entity; the technical problems and solutions described herein arise whenever hierarchical task delegation produces verification outcomes that must be aggregated upward through a tree-structured hierarchy under concurrent execution.

### Description of Related Art

### Hierarchical Task Delegation in Distributed Systems

Modern computing environments increasingly employ distributed computational entities including autonomous software agents, microservices, robotic process automation (RPA) bots, IoT device controllers, and human-supervised workflow participants—that perform tasks on behalf of principals or other computational entities. These entities operate across heterogeneous platforms, communicate via standardized protocols, and may delegate portions of their assigned work to other entities, creating hierarchical delegation structures. The specific nature of the performing entity (whether an AI agent communicating via an agent-to-agent protocol, a microservice responding to API calls, an RPA bot executing screen-level automation, or a human operator using a task management interface) is immaterial to the verification propagation problem addressed by the present invention.

When a principal or computational entity assigns a task to a performing entity, the assignment constitutes an agreement record specifying acceptance criteria, tolerance bands, and deadlines. The performing entity may, in turn, delegate sub-portions of the task to other entities, each receiving their own agreement record. This creates a tree-structured hierarchy of agreement records, referred to herein as a “delegation chain.” Such hierarchical delegation arises naturally in diverse domains: supply chain orchestration (where a logistics coordinator delegates to carriers, who delegate to local couriers), financial transaction processing (where a payment processor delegates sub-operations to clearing networks and compliance checkers), infrastructure provisioning (where a deployment orchestrator delegates to regional provisioners, who delegate to individual resource managers), and multi-agent AI systems (where a planning agent delegates to specialist agents, who may further sub-delegate).

### The Verification Problem in Delegation Chains

A fundamental problem arises when verification of task completion must propagate upward through such delegation chains. Consider a scenario where Entity A delegates a task to Entities B, C, and D (sibling sub-tasks). Each sub-task undergoes independent verification. When all sibling sub-tasks have been verified, the parent task assigned to Entity A must also be verified based on the aggregate results of its children.

This “sibling-complete upward propagation” problem presents several technical challenges that existing systems fail to address:

Challenge 1: Concurrent Completion of Sibling Tasks. When Entities B and C complete their sub-tasks simultaneously, two concurrent processes attempt to check whether all siblings are complete and, if so, update the parent task's verification state. Without proper concurrency control, both processes may read the parent's state before either writes to it, resulting in duplicate state transitions, lost updates, or data corruption. This is a classic “lost update” anomaly in database systems, but it manifests uniquely in hierarchical verification contexts because the triggering events (sibling completions) are independent and asynchronous.

Challenge 2: Atomicity of Aggregate Verification with Audit Trail. When a parent task's verification state changes due to cascading results from its children, the state transition and the corresponding audit trail entry must be recorded atomically. If the state transition succeeds but the audit entry fails (or vice versa), the system enters an inconsistent state where the audit trail no longer reflects the actual state history. Existing systems treat audit logging as a secondary, eventually-consistent concern, which is insufficient for systems requiring tamper-evident verification records.

Challenge 3: Recursive Propagation Without Unbounded Resource Consumption. In a delegation chain of depth N, completion of a leaf task may trigger cascading verification through N−1 ancestor levels. If this propagation occurs synchronously within a single database transaction, the transaction holds row-level locks across all ancestor records for an unbounded duration, creating deadlock risk and reducing system throughput. Conversely, if propagation is fully asynchronous with no coordination, the system may process propagation events out of order or lose propagation events entirely.

Challenge 4: Circular Delegation Prevention. Without explicit cycle detection, a computational entity could delegate a task back to an ancestor in the delegation chain, creating an infinite loop in the verification propagation path.

### Inadequacy of Existing Solutions

A variety of existing systems address portions of the hierarchical task management and audit trail problem space, but none addresses the specific combination of challenges described above-namely, concurrent sibling-complete aggregation with atomic cryptographic audit trail maintenance and bounded recursive propagation. The following categories of prior art are examined in turn:
1. Distributed workflow orchestration engines (e.g., Apache Airflow, Temporal.io, AWS Step Functions, Prefect, Dagster) provide mechanisms for task dependency management, retry logic, and directed acyclic graph (DAG) execution. However, these systems require the developer to explicitly code aggregation logic for each parent-child relationship. They do not provide a generic, declarative mechanism for “when all children reach a terminal verification state, atomically compute the parent's verification outcome.” Furthermore, they treat task completion and audit logging as separate concerns: a task may be marked complete in the orchestrator's internal state store while the corresponding audit record is written asynchronously or not at all. None of these systems integrates cryptographic audit trail writes (hash-chained, digitally signed) into the same atomic database transaction as the state transition. Additionally, these orchestrators manage workflow execution (scheduling, retrying, and routing tasks), whereas the present invention is concerned solely with verification outcome propagation-a fundamentally different problem that arises after task execution, when completion attestations must be evaluated and their results aggregated upward through a hierarchy.
2. Business process management (BPM) engines (e.g., Camunda, jBPM, Bonita, Oracle BPM Suite, IBM Business Automation Workflow) model processes using BPMN 2.0 or similar notations and support parallel gateways that synchronize multiple branches. However, BPM engines are designed primarily for human-oriented and semi-automated workflows where task completion occurs at human timescales (minutes to days), and the probability of truly concurrent sibling completion is low. Their synchronization gateways assume that branch completion events arrive sequentially through a single process engine instance; they do not address the database-level concurrency problem that arises when independent worker processes detect sibling completion simultaneously and contend for the same parent record. BPM engines also do not maintain per-record cryptographic hash chains-their audit trails are typically append-only event logs without hash-chain linkage or digital signatures, and audit writes are not guaranteed to be atomic with state transitions. Furthermore, BPM process definitions are typically static and designed at modeling time, whereas the delegation hierarchies addressed by the present invention are constructed dynamically at runtime through delegation decisions made by computational entities during operation.
3. Hierarchical state machine frameworks (e.g., Statecharts as formalized by Harel, SCXML, XState, the State pattern in object-oriented design) provide formal mechanisms for nested states, parallel regions, and history states within a single computational entity. However, hierarchical state machines model the internal state of a single entity or process they do not address the distributed coordination problem that arises when multiple independent processes (each managing a different sibling task) must converge on a shared parent record stored in an external persistent data store. A parallel region in a statechart assumes that all parallel sub-states are managed within the same runtime process and share memory; it provides no mechanism for row-level database locking, cross-transaction serialization, or durable message queue coordination between independent worker processes. The concurrency problem addressed by the present invention is fundamentally a distributed systems problem, not a state modeling problem, and hierarchical state machine frameworks do not provide the transactional semantics or distributed coordination mechanisms required.
4. Saga pattern implementations (e.g., Eventuate Tram, Mass Transit Sagas, Axon Saga) focus on compensating transactions across distributed services-ensuring that if one step in a multi-step distributed transaction fails, previous steps are reversed through compensation. Sagas address the problem of maintaining consistency across services that each own their own data store. The present invention addresses a different problem: concurrent sibling completion triggering a single aggregate computation on a shared parent record within a single authoritative data store. Sagas do not provide a mechanism for “when all compensable steps have reached terminal states, atomically compute an aggregate outcome and write a cryptographic audit entry.” The choreography-based saga pattern, in particular, relies on eventual consistency and event-driven coordination that cannot guarantee the serialized, atomic aggregation required by the present invention.
5. Event sourcing systems (e.g., EventStoreDB, Axon Framework, Marten) maintain an append-only log of state changes and reconstruct current state by replaying events. While event sourcing provides a natural audit trail (the event log itself), it introduces several problems in the hierarchical verification context. First, determining the current state of a parent record requires replaying its entire event history, introducing read amplification and latency that grows with the number of state transitions. Second, event sourcing does not inherently prevent concurrent aggregate computation from producing conflicting results: two concurrent processes may each replay the same event log, each determine that all siblings are complete, and each emit a “parent verified” event, producing duplicate or conflicting state transitions. The optimistic concurrency control typically used in event stores (expected sequence number on append) addresses single-stream conflicts but does not solve the cross-stream aggregation problem where the relevant information (sibling states) spans multiple event streams. Third, event sourcing systems do not typically integrate cryptographic hash-chain verification into the event append operation, and the hash integrity of the event log is maintained by the event store infrastructure rather than being enforced within the application's transactional boundary.
6. Database trigger mechanisms (e.g., PostgreSQL triggers, MySQL triggers, Oracle database triggers) can detect child record changes and update parent records automatically. However, database triggers execute within the triggering transaction's context, which means that a leaf-level task completion would hold row-level locks through the entire propagation chain as the trigger cascades upward through ancestor records. In a delegation chain of depth N, the triggering transaction would acquire and hold locks on N records simultaneously, creating the unbounded resource consumption and deadlock risk described in Challenge 3. Furthermore, trigger-based propagation is synchronous and cannot be deferred to a separate transaction per level, which means that the failure of any ancestor-level propagation step would roll back the leaf-level completion—an undesirable coupling between independent verification events. Database triggers also lack the ability to integrate durable message queue coordination, hash-chain audit writes, and state machine validation logic without embedding substantial application logic in stored procedures, which creates maintainability and testability problems.
7. Blockchain and distributed ledger audit systems (e.g., Hyperledger Fabric, Ethereum event logs, Amazon QLDB, Immudb) provide tamper-evident or immutable record keeping through various consensus and hash-chain mechanisms. However, these systems introduce several characteristics that are unnecessary or counterproductive for the hierarchical verification propagation problem. First, blockchain consensus mechanisms (proof-of-work, proof-of-stake, PBFT) impose significant latency and throughput constraints—typically hundreds of milliseconds to seconds per confirmed write—that are unnecessary when a single authoritative relational data store manages the state and no distributed consensus is required. The present invention achieves equivalent tamper-evidence (SHA-256 hash chains with Ed25519 digital signatures) within a standard ACID database transaction at microsecond cost, because the trust model does not require multi-party consensus. Second, blockchain systems cannot guarantee atomicity between a state transition in one data structure (the task record) and an audit entry in another (the ledger) within a single database transaction, because the blockchain write is an external operation with its own commit semantics. The present invention's critical property—that the state transition and the hash-chained audit entry are committed atomically in a single database transaction, such that no audit gap can exist—is architecturally impossible in a system where the audit log is maintained by a separate distributed ledger. Third, permissioned ledger systems such as Amazon QLDB provide append-only verified history for individual records, but do not provide the cross-record aggregation semantics needed for sibling-complete verification: determining that all sibling records have reached terminal states, computing an aggregate outcome, and atomically transitioning the parent record—all within a single serializable transaction.
8. Hybrid orchestration-audit architectures that combine a workflow engine with a separate audit logging system (e.g., Temporal with an ELK stack, Airflow with a compliance database, Camunda with a blockchain notarization service) suffer from the fundamental problem that the orchestration state transition and the audit record write occur in different systems with different transactional boundaries. This creates a window of inconsistency: the state may be updated while the audit write is pending, failed, or delayed, or the audit entry may be written for a state transition that is subsequently rolled back. The present invention eliminates this window by performing both operations within a single database transaction, ensuring that the audit trail is always exactly consistent with the operational state-a property that is not achievable when the audit system is external to the state management system.

There is therefore a need for a system and method that provides atomic, concurrency-safe upward propagation of verification outcomes through hierarchical delegation chains, with integrated cryptographic audit trail maintenance and bounded resource consumption at each propagation level. This need exists independently of the nature of the computational entities performing the delegated tasks-whether autonomous software agents, microservices, robotic systems, or human-supervised processes- and is not addressed by any existing category of workflow, orchestration, state management, or audit system, individually or in combination.

### BRIEF SUMMARY OF THE INVENTION

The present invention provides a system and method for maintaining data integrity during hierarchical task verification in distributed computing environments. At its core, the invention addresses a fundamental problem in concurrent distributed systems: hierarchical state aggregation under concurrency constraints with atomic audit integrity. The delegated operations may be performed by autonomous software agents, enterprise systems, robotic systems, or human-supervised computational agents; the invention is agnostic to the nature of the performing entity and applies wherever hierarchical task delegation produces verification outcomes that must be aggregated upward through a tree-structured hierarchy. Specifically, when records organized in a tree-structured hierarchy must aggregate child states into parent states, and multiple children may reach terminal states concurrently from independent processes, the system must (1) serialize competing aggregation computations at each parent node to prevent conflicting state transitions, (2) atomically commit both the aggregated state transition and a tamper-evident audit record within a single database transaction to guarantee consistency between the operational state and the audit trail, and (3) propagate the aggregated result upward through the hierarchy without holding locks across multiple levels, bounding resource consumption regardless of tree depth. The system employs a combination of row-level exclusion locking, sibling-complete aggregation, atomic audit trail writes, and deferred recursive propagation via a durable message queue to ensure that verification outcomes propagate correctly through delegation chains of arbitrary depth (up to a configured maximum) without data corruption, even when multiple sibling tasks complete concurrently.

In accordance with the present invention, a method for propagating verification outcomes in a hierarchical distributed task verification system comprises: (a) receiving, at a durable message queue worker, a signal indicating that a sub-task record has reached a terminal verification state; (b) acquiring a row-level exclusion lock on the parent task record in a persistent relational data store; (c) querying all sibling task records sharing the same parent reference; (d) determining whether all sibling task records have reached terminal verification states; (e) if all siblings are in terminal states, computing an aggregate verification outcome based on the terminal states of all siblings; (f) atomically transitioning the parent task record through a series of intermediate states in a defined state machine to a terminal verification state corresponding to the aggregate outcome; (g) appending a cryptographically chained audit entry to an append-only audit store within the same database transaction as step (f); (h) committing the transaction; and (i) if the parent task record itself has a parent reference, enqueuing a deferred propagation job to the durable message queue for the next ancestor level, the deferred propagation job causing a separate worker process to perform steps (a) through (g) for the next ancestor level in a separate database transaction, up to a configured maximum delegation depth.

The key innovations of the present invention include:
1. Row-level exclusion locking for sibling-complete aggregation: The system acquires a SELECT . . . FOR UPDATE lock on the parent record before evaluating sibling states, ensuring that concurrent sibling completions are serialized at the parent level without requiring table-level locks or application-level distributed locks.
2. Atomic state transition with cryptographic audit trail: The parent's state machine transition and the corresponding hash-chained audit vault entry are written within a single database transaction, ensuring that the audit trail is always consistent with the actual state history.
3. Deferred recursive propagation via durable message queue: After committing the parent's state transition, the system enqueues a new propagation job for the next ancestor level (if any) through a durable message queue, rather than propagating within the same transaction. This bounds the lock duration at each level to a single parent-sibling aggregation, prevents deadlocks, and ensures that propagation survives process failures through the queue's durability guarantees.
4. Circular delegation prevention via recursive ancestor traversal: When creating a delegation relationship, the system executes a recursive common table expression (CTE) query that walks the delegation chain from the proposed parent to the root, checking whether the proposed performer agent appears anywhere in the chain. This prevents cycles that would cause infinite propagation loops.
5. Bounded delegation depth: The system enforces a configurable maximum delegation chain depth (in the preferred embodiment, five levels), providing an absolute upper bound on the depth of recursive propagation.

### BRIEF DESCRIPTION OF THE DRAWINGS

FIG. 1 is a block diagram illustrating the system architecture of the hierarchical distributed task verification system, showing the API server, persistent relational data store, durable message queue, queue worker process, and in-process event bus, and the interactions between these components.

FIG. 2 is a structural diagram illustrating a delegation chain hierarchy, showing a root mandate with sub-mandates at multiple levels, and the data fields (chain_depth, parent_mandate_id, root_mandate_id, enterprise_id) that link mandate records in the hierarchy.

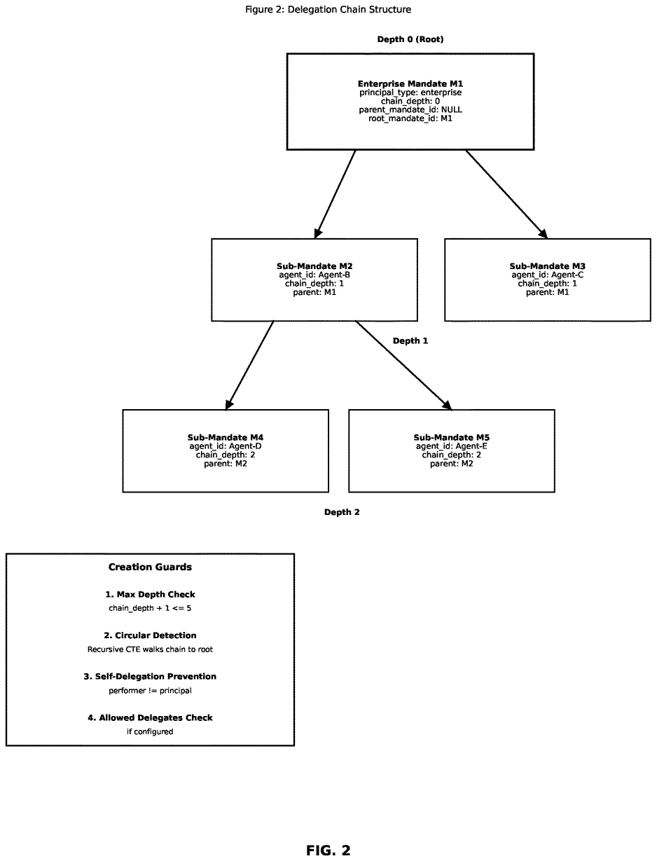

FIG. 3 is a flowchart illustrating the sibling-complete aggregation flow, showing the sequence of operations from receiving a cascading job through acquiring the row-level exclusion lock, querying siblings, computing the aggregate outcome, transitioning the parent mandate through intermediate states, appending audit entries, committing the transaction, and enqueuing the next cascading job.

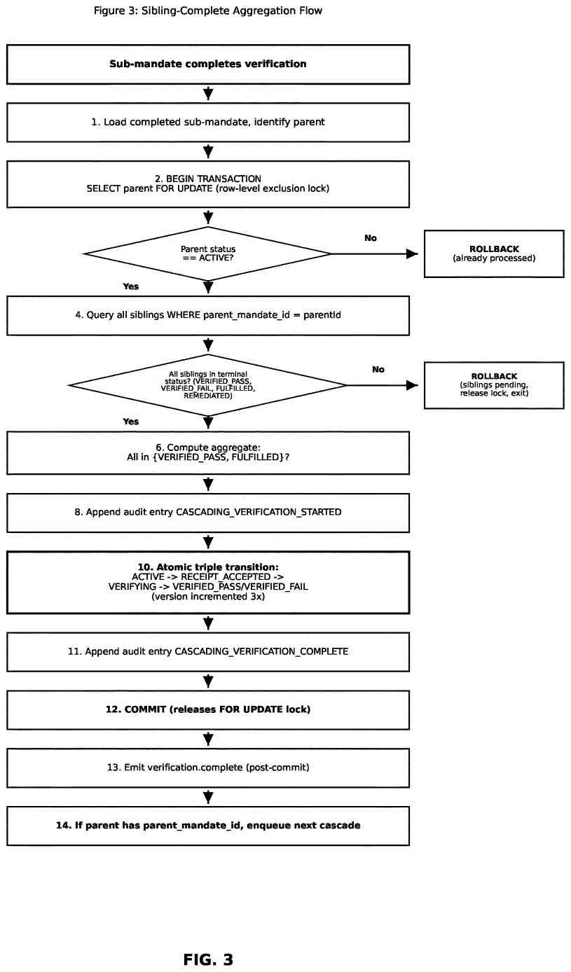

FIG. 4 is a timing diagram illustrating the concurrency race condition that arises when multiple sibling sub-mandates complete simultaneously, and how the row-level exclusion lock (SELECT . . . FOR UPDATE) prevents the race condition by serializing concurrent cascading verification workers at the parent record.

FIG. 5 is a state machine diagram illustrating the mandate lifecycle states and permitted transitions, including the intermediate states traversed during cascading verification (ACTIVE to RECEIPT_ACCEPTED to VERIFYING to VERIFIED_PASS or VERIFIED_FAIL).

FIG. 6 is a sequence diagram illustrating recursive upward propagation through a three-level delegation chain, showing how verification completion at the leaf level triggers cascading propagation through intermediate and root levels via the durable message queue, with each level processed in an independent database transaction.

FIG. 7 is a diagram illustrating configurable aggregation policies, showing three policy types applied to the same parent-child verification scenario: a unanimous policy requiring all sibling task specification records to pass, a majority policy requiring more than half to pass, and a weighted policy applying numeric weights with a configurable threshold.

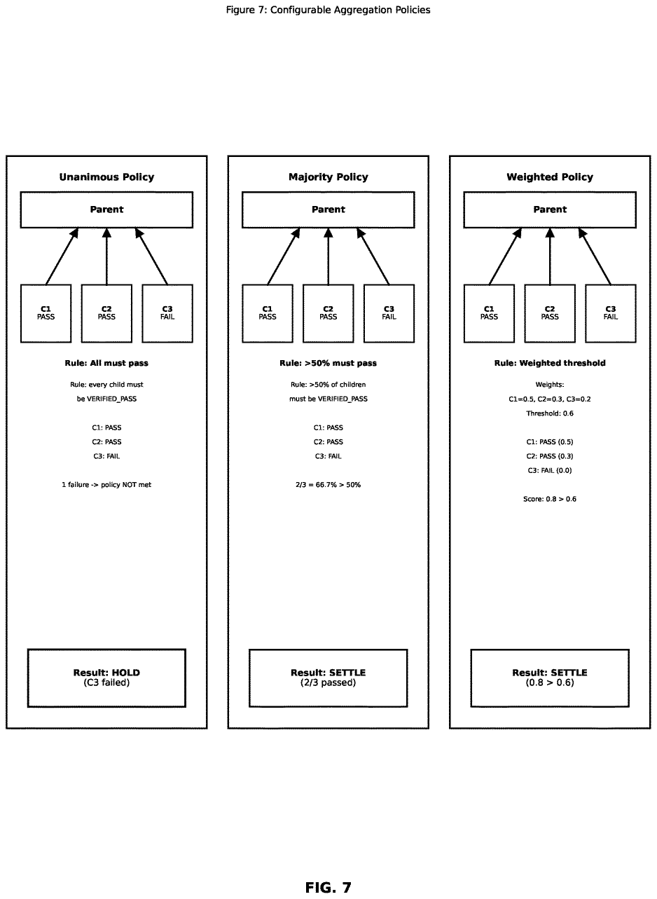

### DETAILED DESCRIPTION OF THE INVENTION

The following detailed description refers to the accompanying drawings and describes a preferred embodiment of the invention. Those skilled in the art will recognize that many modifications and variations are possible within the scope of the invention as defined by the appended claims.

As used herein, the term “task specification record” refers to a persistent data record comprising a task description, acceptance criteria, assigned performer identifier, and lifecycle state. In the preferred embodiment described herein, task specification records are referred to as “mandates.” The terms are used interchangeably throughout this specification, with “mandate” referring to the specific implementation and “task specification record” referring to the broader concept.

As used herein, the term “agent” or “performing agent” refers to any computational entity capable of receiving a task specification record, performing the specified work, and submitting a task completion attestation. Agents as described herein include, without limitation, autonomous software agents communicating via agent-to-agent protocols, microservices responding to API calls, robotic process automation (RPA) bots, IoT device controllers, enterprise workflow participants, and human operators interacting through computational interfaces. The term is used as a convenience throughout the preferred embodiment description and should not be construed as limiting the invention to any particular category of computational entity. The technical problems and solutions described herein-concurrent sibling-complete aggregation, atomic audit trail maintenance, and bounded recursive propagation-arise whenever hierarchical task delegation produces verification outcomes that must be aggregated upward, regardless of the nature of the entity performing the delegated work.

### 1. System Architecture

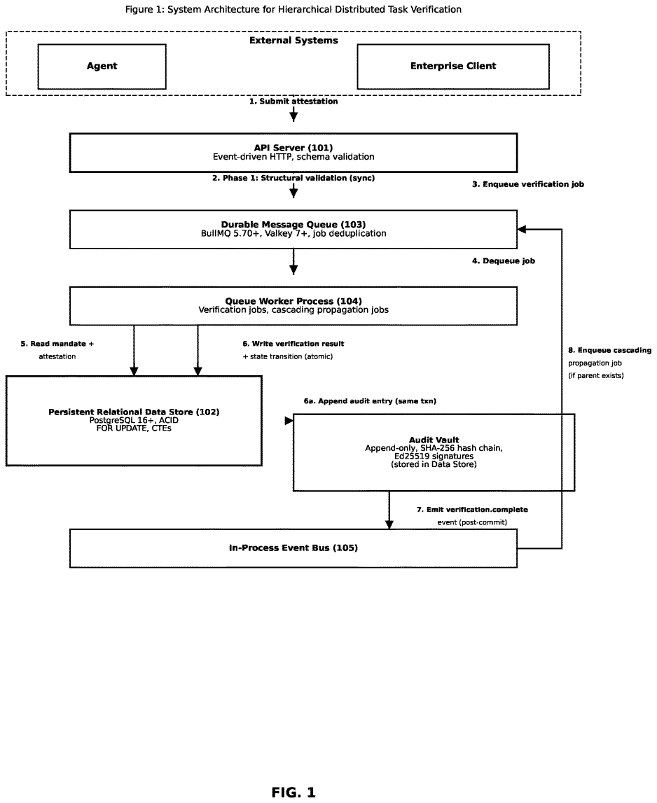

Referring now to FIG. 1, the system of the present invention comprises four principal components:

A. Application Programming Interface (API) Server (101). In one embodiment, the API server is implemented as an event-driven, non-blocking HTTP server that receives task registration requests, task completion attestation submissions, and delegation chain creation requests from external agents and enterprise systems. The API server validates incoming requests against predefined schemas using a schema validation engine. In the preferred embodiment, the API server is implemented using a plugin-based web framework (for example, Fastify 5.x) running on a JavaScript runtime (for example, Node.js 22+).

B. Persistent Relational Data Store (102). The relational data store maintains the authoritative state of all task records (referred to herein as “mandate records”), audit trail entries, verification results, and delegation chain relationships. In the preferred embodiment, the relational data store is a PostgreSQL 16+ instance providing ACID transaction guarantees, row-level locking via SELECT . . . FOR UPDATE, and recursive common table expression (CTE) support. The data store enforces referential integrity through foreign key constraints and optimistic concurrency through version counters.

C. Durable Message Queue (103). The durable message queue provides reliable, at-least-once delivery of asynchronous processing jobs. Two categories of jobs are relevant to the present invention: (i) verification jobs, which perform semantic verification of task completion attestations against mandate criteria, and (ii) cascading propagation jobs, which trigger the sibling-complete aggregation algorithm on parent records. In the preferred embodiment, the durable message queue is implemented using BullMQ 5.70+ backed by a Valkey 7+ (Redis-compatible) in-memory data store configured with a noeviction memory policy to prevent loss of queue entries. Job deduplication prevents duplicate processing of the same cascading event.

D. Queue Worker Process (104). The worker process consumes jobs from the durable message queue and executes the corresponding verification or cascading propagation logic. The worker operates as a separate process from the API server, enabling independent scaling and ensuring that long-running verification computations do not block API request handling. In the preferred embodiment, the worker process runs on ARM64 container instances with configurable concurrency and a graceful shutdown mechanism that races worker closure against a 25-second timeout to accommodate container orchestration kill signals.

E. In-Process Event Bus (105). An in-process event emitter provides fire-and-forget notification of state changes within the API server and worker processes. When a verification job completes (either through direct verification or cascading propagation), the worker emits a verification.complete event. A registered handler on this event bus checks whether the completed mandate has a parent reference and, if so, enqueues a cascading propagation job to the durable message queue. This two-stage design (synchronous event emission followed by durable queue enqueue) ensures that the triggering transaction commits before propagation is attempted, while the durable queue ensures propagation survives process failures.

The interaction between these components proceeds as follows: An external agent submits a task completion attestation to the API server (101). The API server validates the attestation structurally (Phase 1, synchronous) and, if valid, enqueues a semantic verification job to the durable message queue (103). The queue worker (104) executes the verification job, which reads the mandate record and attestation from the relational data store (102), applies verification rules, and writes the verification result and state transition atomically back to the data store. Upon successful commit, the worker emits a verification.complete event on the in-process event bus (105). If the completed mandate has a parent reference (i.e., it is a sub-mandate in a delegation chain), the event handler enqueues a cascading propagation job to the durable message queue. The worker subsequently processes this cascading job by executing the sibling-complete aggregation algorithm described in Section 5.

### 2. Data Model

The mandate record is the central data structure in the system. Each mandate record is stored as a row in the relational data store with the following fields relevant to delegation chain verification:

Primary Identification: -mandate_id (UUID, primary key): A universally unique identifier assigned at creation time. Generated using the data store's built-in cryptographic random UUID generator (gen_random_uuid( )).

Delegation Chain References: -parent_mandate_id (UUID, nullable, foreign key referencing mandate_id): A reference to the parent mandate record in the delegation hierarchy. A value of NULL indicates a root-level mandate with no parent. A non-NULL value indicates that this mandate is a sub-mandate created through delegation. -root_mandate_id (UUID, nullable, foreign key referencing mandate_id): A direct reference to the root mandate at the top of the delegation chain. This field enables efficient retrieval of all records in a delegation chain without recursive traversal. For root-level mandates, this field references the mandate's own identifier. Computed at creation time. -chain_depth (INTEGER, NOT NULL, default 0): The zero-indexed depth of this mandate in the delegation chain. A root mandate has chain_depth=0. A direct child of the root has chain_depth=1. This field is computed at creation time as parent.chain_depth+1 and is used for maximum depth enforcement.

Verification State: -status (VARCHAR, NOT NULL, default ‘DRAFT’): The current lifecycle state of the mandate, drawn from a closed set of enumerated values constituting a state machine. The verification-relevant states and their transitions are described in Section 7. -version (INTEGER, NOT NULL, default 1): An optimistic concurrency control counter. Every state transition increments this counter by one. State transition operations include the current version in their conditional update clause (WHERE id=$1 AND version=$2), ensuring that concurrent modifications are detected and serialized. -last_transition_reason (VARCHAR, nullable): A machine-readable identifier indicating the cause of the most recent state transition (e.g., ‘cascading_verification’, ‘receipt_submitted’, ‘manual_cancellation’). Updated atomically with each state transition. -last_transition_by (VARCHAR, nullable): An identifier of the computational entity or system process that triggered the most recent state transition (e.g., the performing agent's identifier, the queue worker's process identifier, or ‘system’ for automated transitions such as expiry). Updated atomically with each state transition. Both last_transition_reason and last_transition_by are included in the corresponding audit vault entry, providing rapid queryability on the mandate record without requiring audit chain traversal for the most recent transition context.

Task Specification: -criteria (JSONB, NOT NULL): A structured JSON object containing the acceptance criteria for the mandate. The structure of this object is governed by a contract type schema (see contract_type below). Acceptance criteria define the measurable conditions that must be met for verification to pass. -tolerance (JSONB, default ‘{ }’): A structured JSON object containing tolerance bands for each criterion. Tolerance bands define acceptable deviation ranges (e.g., quantity within +/−5%, delivery date within 24-hour window). -contract_type (VARCHAR, NOT NULL): An identifier for the category of agreement (e.g., ‘ACH-PROC-v1’ for procurement, ‘ACH-ORCH-v1’ for orchestration/delegation). The contract type determines which verification rules are applied and which JSON schemas govern the criteria and attestation evidence structures. -contract_version (VARCHAR, NOT NULL): The version of the contract type schema.

Principal and Performer Identification: -agent_id (UUID, nullable, foreign key): The identifier of the performing agent assigned to fulfill this mandate. In the delegation chain context, this is the agent that will execute the work or further delegate it. -enterprise_id (UUID, nullable, foreign key): The identifier of the enterprise that originated the mandate chain. This field may be NULL for agent-to-agent mandates that do not originate from an enterprise. Inherited from the parent mandate during delegation. -principal_type (VARCHAR, NOT NULL, default ‘enterprise’): Indicates whether the principal (creator) of this mandate is an enterprise or an agent. Constrained to values ‘enterprise’ or ‘agent’. -principal_agent_id (UUID, nullable, foreign key): When principal_type is ‘agent’, this field identifies the agent that created the mandate. In a delegation scenario, this is the agent that received the parent mandate and delegated a sub-portion to the performing agent.

Delegation Authorization: -allowed_delegates (JSONB, nullable): An optional array of agent identifiers that the performing agent is authorized to delegate to. When present, the system enforces that any sub-mandate's performing agent appears in this allowlist. When NULL, delegation is unrestricted (subject to other validation rules). -commission_pct (DECIMAL(5,2), nullable): For delegated sub-mandates, the percentage commission retained by the delegating agent. Informational only; the system does not transfer funds. -commission_amount (DECIMAL(12,2), nullable): Computed aggregate commission amount, calculated when cascading verification determines all sub-mandates have passed.

Temporal Fields: -created_at (TIMESTAMPTZ, default NOW( )): Creation timestamp. -updated_at (TIMESTAMPTZ, default NOW( )): Last modification timestamp, updated on every state transition. -activated_at (TIMESTAMPTZ, nullable): Timestamp when the mandate transitioned to the ACTIVE state. -fulfilled_at (TIMESTAMPTZ, nullable): Timestamp when the mandate transitioned to the FULFILLED terminal state. -deadline (TIMESTAMPTZ, nullable): The deadline by which the performing agent must submit a task completion attestation.

Database Constraints: The mandate table enforces referential integrity through foreign key constraints on parent_mandate_id (self-referencing), root_mandate_id (self-referencing), agent_id, enterprise_id, and principal_agent_id. A check constraint ensures that enterprise mandates have a non-NULL enterprise_id and agent mandates have a non-NULL principal_agent_id:

```
CHECK (
  (principal_type = ‘enterprise’ AND enterprise_id IS NOT NULL)
  OR
  (principal_type = ‘agent’ AND principal_agent_id IS NOT NULL)
)
```

Each mandate record references at most one parent mandate record via the parent mandate identifier, forming a forest of rooted trees. A forest of rooted trees is a special case of a directed acyclic graph in which each node has at most one parent.

Indexes for Delegation Chain Operations: -idx_mandates_parent: B-tree index on (parent_mandate_id) with partial condition WHERE parent_mandate_id IS NOT NULL. Accelerates sibling queries during cascading verification. -idx_mandates_root: B-tree index on (root_mandate_id) with partial condition WHERE root_mandate_id IS NOT NULL. Accelerates full-chain retrieval. -idx_mandates_root_chain: B-tree index on (root_mandate_id, chain_depth, created_at) with partial condition WHERE root_mandate_id IS NOT NULL. Accelerates ordered chain traversal.

### 3. Delegation Chain Creation

When a performing agent wishes to delegate a portion of its assigned work to another agent, the system creates a new mandate record linked to the original mandate through the parent_mandate_id reference. The delegation chain creation process enforces several invariants to prevent invalid chain structures.

Step 1: Self-Delegation Prevention. The system verifies that the proposed performing agent identifier differs from the principal agent identifier. If they are identical, the system rejects the request with a validation error. This prevents an agent from delegating a task to itself, which would create a degenerate chain with no useful delegation.

Step 2: Commission Validation. If a commission percentage is specified, the system verifies that a parent mandate identifier is also specified. Commission tracking is only meaningful for delegated sub-mandates; specifying a commission on a root-level mandate is rejected as a validation error.

Step 3: Parent Mandate Validation. If a parent mandate identifier is provided, the system loads the parent mandate record from the relational data store and validates: —The parent mandate exists. —The parent mandate's current chain_depth plus one does not exceed the configured maximum chain depth (in the preferred embodiment, 5). This bounds the depth of the delegation hierarchy and, consequently, the maximum depth of recursive verification propagation. —The requesting agent (the principal of the new sub-mandate) is the performing agent (agent_id) on the parent mandate. This ensures that only the agent assigned to a task can further delegate portions of it. —The parent mandate is in the ACTIVE state. Delegation is only permitted from active mandates. —If the parent mandate has an allowed_delegates array, the proposed performing agent must appear in that array.

Step 3A: Acceptance Criteria Schema Validation. Before inserting the mandate record into the relational data store, the system validates the acceptance criteria (the criteria field) against a predefined JSON Schema associated with the specified contract type. Each contract type (e.g., ‘ACH-PROC-v1’ for procurement, ‘ACH-ORCH-v1’ for orchestration) has a corresponding mandate criteria schema that defines the required fields, field types, value constraints, and structural invariants for that category of agreement. The system loads the compiled schema validator for the specified contract type and version, applies it to the provided criteria, and rejects the mandate creation with a validation error if the criteria do not conform to the schema. This validation occurs at creation time—before the mandate enters the delegation hierarchy—ensuring that structurally invalid acceptance criteria never propagate through delegation chains and never reach the verification engine. In the preferred embodiment, schema validators are compiled once from JSON Schema (draft-07) definitions and cached by contract type and version for reuse.

Step 4: Circular Delegation Prevention. This is a critical safety check that prevents cycles in the delegation chain, which would cause infinite loops during verification propagation. The system executes a recursive common table expression (CTE) query against the relational data store:

```
FUNCTION detectCircularDelegation(parentMandateId, proposedPerformerAgentId):
  WITH RECURSIVE chain AS (
    - - Base case: start from the proposed parent
    SELECT id, agent_id, principal_agent_id, parent_mandate_id
    FROM mandate_records
    WHERE id = parentMandateId
    UNION ALL
    - - Recursive case: walk up to each ancestor
    SELECT m.id, m.agent_id, m.principal_agent_id, m.parent_mandate_id
    FROM mandate_records m
    JOIN chain c ON m.id = c.parent_mandate_id
  )
  - -
  Check if the proposed performer appears anywhere in the chain
  SELECT EXISTS(
    SELECT 1 FROM chain
    WHERE agent_id = proposedPerformerAgentId
  OR principal_agent_id = proposedPerformerAgentId
  ) AS circular_detected
  IF circular_detected THEN
    REJECT with “Circular delegation detected”
  END IF
```

This recursive CTE starts at the proposed parent mandate and walks upward through the delegation chain by following parent_mandate_id references until it reaches a root mandate (where parent_mandate_id is NULL). At each level, it checks whether the proposed performing agent already appears as either the performing agent (agent_id) or the principal agent (principal_agent_id). If the proposed performer is found anywhere in the ancestor chain, the delegation is rejected.

The maximum depth constraint (Step 3) guarantees that this recursive query terminates in at most N iterations, where N is the maximum chain depth.

Step 5: Chain Metadata Computation. The system computes the delegation chain metadata for the new record: -chain_depth is set to parent.chain_depth+1. -root_mandate_id is set to parent.root_mandate_id if the parent itself has a root reference, otherwise to the parent's own mandate_id. This ensures all records in a chain share the same root reference. -enterprise_id is inherited from the parent mandate if not explicitly provided, ensuring enterprise lineage is preserved through the delegation chain.

Step 6: Record Creation and Audit. The new mandate record is inserted into the relational data store within a database transaction. An audit vault entry of type MANDATE_DELEGATED is appended within the same transaction, recording the delegation event with full context (parent reference, chain depth, principal and performer identifiers). The transaction is then committed.

Step 7: Event Emission. After the transaction commits, a mandate.delegated event is emitted on the in-process event bus, notifying subscribers of the new delegation relationship. This event is fire-and-forget; the delegation is already durably recorded.

### 4. Verification Completion Signal

When a mandate's verification process completes (either through direct verification of a task completion attestation or through the cascading propagation described in Section 5), the system emits a verification completion signal that triggers cascading propagation if the mandate is a sub-mandate in a delegation chain.

The verification completion signal has the following structure:

VerificationCompletionSignal {

| mandateId: | UUID | - - The mandate that completed verification |
|---|---|---|
| receiptId: | String | - - The task attestation identifier (or ‘cascaded’ for propagated |
| results) | | |
| agentId: | UUID | - - The performing agent |
| contractType: | String | - - The contract type indentifier |
| outcome: | Enum | - - ‘PASS’ or ‘FAIL’ |
| signal: | Enum | - - ‘SETTLE’ or ‘HOLD’ (dervived from outcome) |
| checks: | Object | - - Detailed verification check results |
| durationMs: | Integer | - - Verification duration in milliseconds |
| parentMandateId: | UUID? | - - Present only if this mandate has a parent (is a sub-mandate) |
| } | | |

A handler registered on the in-process event bus listens for verification completion signals. When a signal is received with a non-null parentMandate Id, the handler enqueues a cascading propagation job to the durable message queue:

FUNCTION onVerificationComplete(signal):
IF signal.parentMandateId IS NULL THEN

| | |
|---|---|
| RETURN | - - Root mandate, no propagation needed |
| END IF | |

enqueue to durable_message_queue:

| | |
|---|---|
| job_name: | ‘cascade’ |
| job_data: | { completedSubMandateId: signal.mandateId } |
| job_id: | ‘cascade-’ + signal.mandateId - - Deduplication key |

The job_id field serves as a deduplication key: if a cascading job for the same sub-mandate identifier already exists in the queue (e.g., due to a retry or duplicate event emission), the queue will not create a duplicate job. This ensures idempotent propagation triggering.

The separation between event emission and queue enqueue is architecturally significant. The verification completion event is emitted only after the verification transaction has committed, ensuring that when the cascading propagation job executes, the triggering sub-mandate's terminal state is visible in the relational data store. If the event bus enqueue were to occur within the verification transaction, a race condition could arise where the cascading worker reads the sub-mandate's state before the triggering transaction commits.

### 5. Sibling-Complete Aggregation Algorithm

The sibling-complete aggregation algorithm is the core invention of the present disclosure. This algorithm is invoked by the queue worker when processing a cascading propagation job. It determines whether all sibling sub-mandates of a given parent have reached terminal verification states and, if so, computes and applies the aggregate verification outcome to the parent.

The algorithm proceeds as follows:

```
FUNCTION checkCascadingVerification(pool, completedSubMandateId, eventBus):
  -- STEP 1: Load the completed sub-mandate and identify its parent
  client = pool.connect( )
  completedSub = findMandateById(client, completedSubMandateId)
  IF completedSub IS NULL OR completedSub.parent_mandate_id IS NULL THEN
    RETURN -- No parent to propagate to
  END IF
  parentId = completedSub.parent_mandate_id
  -- STEP 2: Begin transaction and acquire row-level exclusion lock on parent
  BEGIN TRANSACTION
  parentRow = SELECT id, status, version
      FROM mandate_records
      WHERE id = parentId
      FOR UPDATE
      - - FOR UPDATE acquires an exclusive row-level lock
      - - Any concurrent cascading job for the same parent will BLOCK here
      - - until this transaction commits or rolls back
  IF parentRow IS NULL THEN
    ROLLBACK
    RETURN
  END IF
  - - STEP 3: Verify parent is in a state that accepts cascading verification
  IF parentRow.status != ‘ACTIVE’ THEN
    ROLLBACK
    RETURN
  -- Parent has already been processed or is in an unexpected state
  END IF
  -- STEP 4: Query all siblings sharing the same parent
  siblings = SELECT * FROM mandate_records
      WHERE parent_mandate_id = parentId
      ORDER BY created_at
      LIMIT 1000
  IF siblings IS EMPTY THEN
    ROLLBACK
    RETURN
  END IF
  -- STEP 5: Check if ALL siblings have reached terminal verification states
  terminalStates = { ‘VERIFIED_PASS’ , ‘VERIFIED_FAIL’ , ‘FULFILLED’, ‘REMEDIATED’ }
  allComplete = ALL siblings s SATISFY(s.status IN terminalStates)
  IF NOT allComplete THEN
    ROLLBACK
    RETURN - - Some siblings still in progress; wait for them
  END IF
  - - STEP 6: Compute aggregate verification outcome
  passingStates = {‘VERIFIED_PASS’ , ‘FULFILLED’}
  allPassed = ALL siblings s SATISFY(s.status IN passingStates)
  - - STEP 7: Re-load full parent record for state machine transitions
  parent = findMandateById(client, parentId)
  IF parent IS NULL THEN
    ROLLBACK
    RETURN
  END IF
  -- STEP 8: Write audit entry marking start of cascading verification
  appendToAuditVault(client, parentId, ‘CASCADING_VERIFICATION_STARTED’, {
    parentMandateId: parentId,
    subMandateIds: siblings.map(s => s.id),
    subMandateStatuses: siblings.map(s => {id: s.id, status: s.status})
  })
  - - STEP 9: Compute commission if all passed and commission rate is configured
  IF allPassed AND parent.commission_pct IS NOT NULL THEN
    totalSubCost = SUM over siblings of extractCostFromCriteria(s. criteria)
    commissionRate = parent.commission_pct / 100
    commissionAmount = totalSubCost * commissionRate
    UPDATE mandate_records SET commission_amount = commissionAmount
    WHERE id = parentId
  END IF
  -- STEP 10: Transition parent through intermediate states atomically
  targetStatus = IF allPassed THEN ‘VERIFIED_PASS’ ELSE ‘VERIFIED_FAIL’
  - - Transition 1: ACTIVE -> RECEIPT_ACCEPTED
  assertValidTransition(parent.status, ‘RECEIPT_ACCEPTED’)
  parent = transitionStatus(client, parentId, parent. version, ‘RECEIPT_ACCEPTED’)
  - - version is now parent.version + 1
  - - Transition 2: RECEIPT_ACCEPTED -> VERIFYING
  assertValidTransition(parent.status, ‘VERIFYING’)
  parent = transitionStatus (client, parentId, parent.version, ‘VERIFYING’)
  -- version is now parent.version + 2
  -- Transition 3: VERIFYING -> VERIFIED_PASS or VERIFIED_FAIL
  assertValidTransition(parent.status, targetStatus)
  transitionStatus(client, parentId, parent.version, targetStatus)
  - - version is now parent.version + 3
  -- STEP 11: Write audit entry marking completion of cascading verification
  appendToAuditVault(client, parentId, ‘CASCADING_VERIFICATION_COMPLETE’, {
    parentMandateId: parentId,
    aggregateOutcome: IF allPassed THEN ‘PASS’ ELSE ‘FAIL’,
    subResults: siblings.map(s => {id: s.id, status: s.status})
  -- STEP 12: Commit the transaction
  COMMIT
  - - At this point:
  - - - Parent's row-level lock is released
  - - - Parent's status is VERIFIED_PASS or VERIFIED_FAIL
  - - - Two audit vault entries have been appended (START and COMPLETE)
  - - - All changes are durable and visible to other transactions
  - - STEP 13: Emit verification completion signal (post-commit)
  eventBus.emit (‘verification.complete’, {
    mandateId: parentId,
    receiptId: ‘cascaded’,
    agentId: parent.agent_id,
    contractType: parent.contract_type,
    outcome: IF allPassed THEN ‘PASS’ ELSE ‘FAIL’,
    signal: IF allPassed THEN ‘SETTLE’ ELSE ‘HOLD’,
    checks: { cascading_verification: {
      ruleId: ‘cascading_verification’,
      pass: allPassed,
      expected: ‘all sub-mandates VERIFIED_PASS’,
      actual: siblings.map(s => s.status).join (‘, ’)
    }},
    durationMs: 0,
    parentMandateId: parent.parent_mandate_id -- Triggers next level if non-null
  })
  -- STEP 14: Emit domain-specific cascading completion event
  eventBus.emit (‘cascading.verification.complete’, {
    parentMandateId: parentId,
    outcome: IF allPassed THEN ‘PASS’ ELSE ‘FAIL’,
    subMandateResults: siblings.map(s => {mandateId: s.id, status: s.status})
  })
```

### Critical Design Decisions in the Algorithm:

Decision 1: The FOR UPDATE lock (Step 2) is acquired on the parent, not the siblings. This is because the parent is the shared resource that multiple concurrent sibling completions contend for. Locking the parent serializes all cascading verification attempts for a given parent, while allowing siblings to complete their own verification concurrently and independently.

Decision 2: The parent must be in ACTIVE state (Step 3). This guard prevents duplicate processing. If two siblings complete simultaneously and both enqueue cascading jobs, the first job to acquire the lock will transition the parent out of ACTIVE state. When the second job acquires the lock, it will find the parent no longer in ACTIVE state and will exit without effect. Combined with the FOR UPDATE lock, this provides exactly-once semantics for cascading verification.

Decision 3: All four terminal states are considered complete (Step 5). The states VERIFIED_PASS and FULFILLED are treated as passing outcomes, while VERIFIED_FAIL and REMEDIATED are treated as failing outcomes. FULFILLED represents a mandate that passed verification and was subsequently acknowledged by the principal. REMEDIATED represents a mandate that failed verification and was subsequently remediated. Both are terminal states that should not block parent aggregation.

REMEDIATED is treated as a failing outcome for sibling-complete aggregation purposes because remediation indicates that the original task completion was deficient and required corrective action, even if the deficiency was subsequently addressed. The remediation event itself is recorded in the audit chain, but for purposes of parent mandate aggregation, a remediated sub-mandate represents a failure in the original verification.

Decision 4: The state machine transition traverses intermediate states (Step 10). Rather than directly transitioning the parent from ACTIVE to VERIFIED_PASS/FAIL, the algorithm walks through ACTIVE->RECEIPT_ACCEPTED->VERIFYING->VERIFIED_PASS/FAIL. Each transition is validated against the state machine's transition rules (Section 7) and increments the version counter. This ensures that the audit trail accurately reflects the full state progression and that no state machine invariants are violated.

Decision 5: Events are emitted after transaction commit (Steps 13-14). This ensures that when the event handler enqueues the next cascading propagation job, the parent's terminal state is visible in the relational data store. If events were emitted within the transaction, a subsequent cascading job might execute before the transaction commits, reading stale state.

### 6. Concurrency Control

The concurrency control mechanism in the sibling-complete aggregation algorithm addresses a specific race condition that arises when multiple sibling sub-mandates complete verification simultaneously. This section describes the race condition in detail and explains how the locking strategy prevents it.

### The Race Condition:

Consider a parent mandate P with three sub-mandates: S1, S2, and S3. S1 and S2 have already completed verification (VERIFIED_PASS). S3 completes verification at time T.

Without locking, two scenarios can lead to data corruption:

Scenario A: Duplicate Propagation. Two verification workers, W1 and W2, are processing cascading jobs for sibling completions that arrive in close temporal proximity. Both W1 and W2 read parent P's status as ACTIVE. Both query the siblings and find all three in terminal states. Both attempt to transition P from ACTIVE to VERIFIED_PASS. The second transition fails due to the optimistic concurrency version check, but this wastes resources and may trigger unnecessary retries.

Scenario B: Phantom Read. Worker W1 reads the sibling states and finds S1 and S2 in VERIFIED_PASS but S3 still in VERIFYING (S3's verification transaction has not yet committed). W1 concludes that not all siblings are complete and exits. Shortly after, S3's verification commits to VERIFIED_PASS. Worker W2, processing the cascading job for S3, reads all three siblings as VERIFIED_PASS and correctly transitions the parent. This scenario is not a correctness problem, but it demonstrates why the system must handle the case where a cascading check finds incomplete siblings gracefully.

Scenario C: Lost Update (the critical case). Without row-level locking, if two workers simultaneously determine that all siblings are complete and both attempt to perform the multi-step state transition (ACTIVE->RECEIPT_ACCEPTED->VERIFYING->VERIFIED_PASS), interleaving of their operations could produce inconsistent state. For example, W1 transitions P to RECEIPT_ACCEPTED, then W2 reads P as RECEIPT_ACCEPTED and attempts to transition to RECEIPT_ACCEPTED again, which the state machine rejects.

### The Locking Strategy:

The SELECT . . . FOR UPDATE clause in Step 2 of the algorithm acquires an exclusive row-level lock on the parent mandate record. This lock is held for the duration of the transaction (until COMMIT or ROLLBACK). The effects of this lock are:
1. Serialization: If two workers attempt to process cascading jobs for siblings of the same parent concurrently, the second worker's SELECT . . . FOR UPDATE query will block until the first worker's transaction completes. The second worker will then read the parent's updated state (including the new status and incremented version) and find that the parent is no longer in ACTIVE state, causing it to exit without effect.
2. Read Consistency: Because the FOR UPDATE lock is acquired before reading the sibling states, and the lock is held until the transaction commits, the sibling states read by the worker are guaranteed to be consistent with the parent's state at the time the lock was acquired. No sibling can be concurrently modified in a way that would change the aggregation result between the sibling read and the parent state transition.
3. No Deadlock Risk (within the algorithm). The algorithm acquires exactly one lock per invocation (the parent record). It never acquires locks on sibling records. Since the lock is always on a single row and no nested locking occurs within the algorithm, deadlock between concurrent cascading verification jobs is impossible.

### Optimistic Concurrency as a Secondary Safety Net:

In addition to the row-level exclusion lock, each state transition uses optimistic concurrency control via the version field. The transition operation is formulated as:

UPDATE mandate_records
SET status = $new_status, version = version + 1, updated_at = NOW( )
WHERE id = $mandate_id AND version = $expected_version
RETURNING *

If the update matches zero rows (because the version has been incremented by a concurrent transaction), the operation throws a conflict error. This provides defense-in-depth: even if the FOR UPDATE lock were somehow circumvented (e.g., due to a bug in transaction management), the optimistic concurrency check would prevent conflicting state transitions.

### Lock Contention Under High Load:

In systems with high rates of sibling completion, the FOR UPDATE lock on the parent may cause brief queueing of cascading verification workers. This is an intentional design trade-off: the lock duration is bounded by a single sibling-complete aggregation (typically milliseconds), and the alternative (application-level distributed locks) would introduce additional failure modes and infrastructure dependencies. In one alternative embodiment, the SKIP LOCKED clause may be used instead of FOR UPDATE, causing a concurrent worker to skip the locked row and rely on a retry mechanism to process it later. However, the preferred embodiment uses blocking FOR UPDATE because the lock duration is short and the retry overhead of SKIP LOCKED is unnecessary.

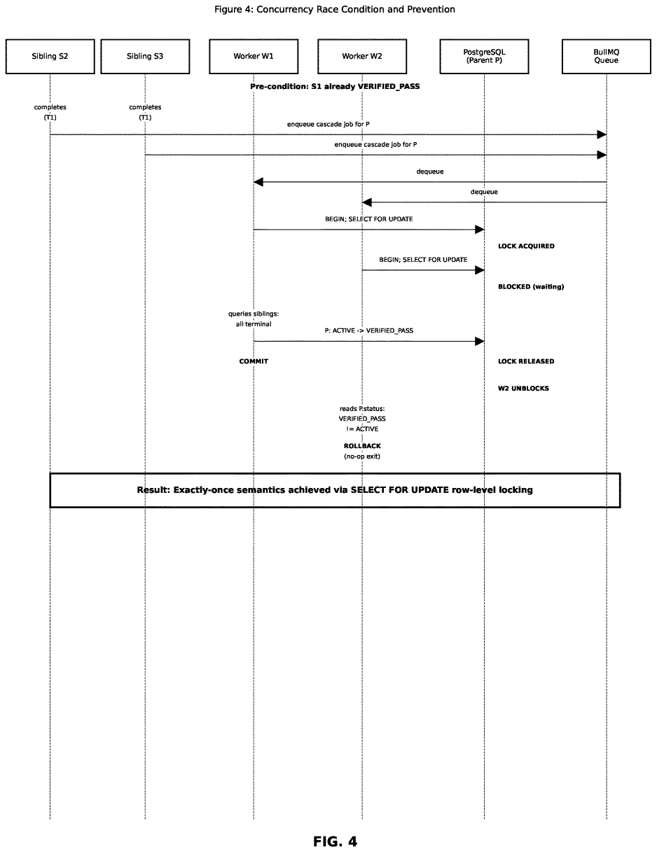

Referring now to FIG. 4, the timing diagram illustrates the difference between the unprotected race condition and the correct behavior achieved by the FOR UPDATE lock. In the unprotected case, Worker W1 and Worker W2 both read the parent's state as ACTIVE at times T1 and T2, respectively, leading to a version mismatch error at time T6. In the protected case, Worker W2's SELECT . . . FOR UPDATE blocks at time T2 until Worker W1 commits at time T5, at which point Worker W2 reads the parent's updated state (VERIFIED_PASS) and exits without modification.

### 7. State Machine

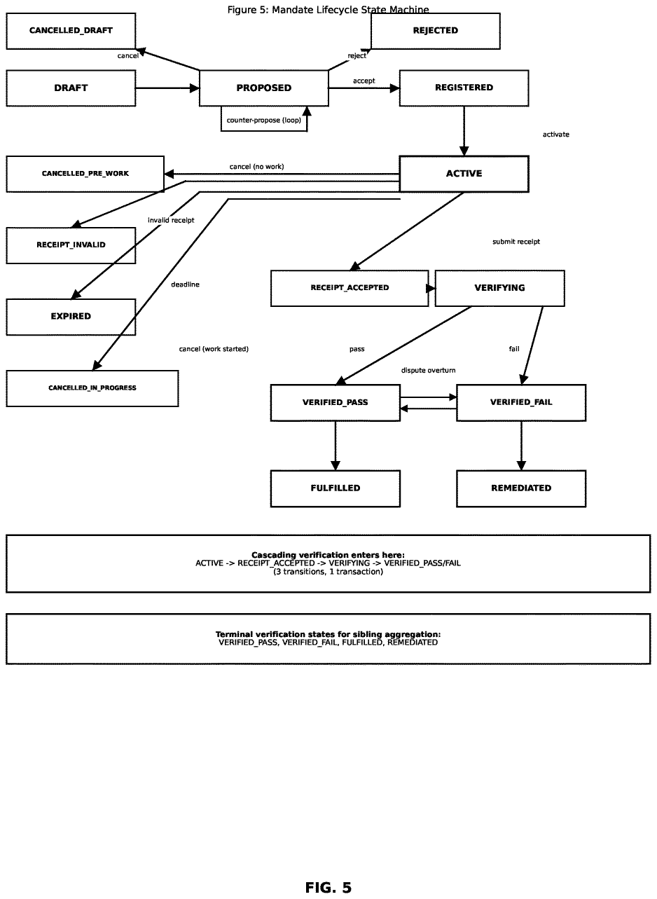

The mandate lifecycle is governed by a deterministic finite state machine with defined transition rules. Referring now to FIG. 5, the following states and transitions are relevant to the delegation chain verification process:

States:

| State | Description | Terminal? |
|---|---|---|
| DRAFT | Initial state upon record creation | No |
| PROPOSED | Mandate proposed by one agent to | No |
| | another, awaiting acceptance | |
| REGISTERED | Mandate terms accepted, awaiting | No |
| | activation | |
| ACTIVE | Mandate is active; performing agent | No |
| | may submit attestation; delegation is | |
| | permitted | |
| RECEIPT_{—} | Submitted attestation failed structural | No |
| INVALID | (Phase 1) validation | |
| RECEIPT_{—} | Attestation passed structural | No |
| ACCEPTED | validation, awaiting semantic | |
| | verification | |
| VERIFYING | Semantic verification (Phase 2) is in | No |
| | progress | |
| VERIFIED_PASS | Verification completed with a passing | No |
| | outcome | |
| VERIFIED_FAIL | Verification completed with a failing | No |
| | outcome | |
| FULFILLED | Post-verification: principal has | Yes |
| | acknowledged passing verification | |
| REMEDIATED | Post-verification: failing | Yes |
| | verification has been remediated | |
| EXPIRED | Deadline passed without attestation | Yes |
| | submission | |
| CANCELLED_{—} | Cancelled from DRAFT state | Yes |
| DRAFT | | |
| CANCELLED_PRE_{—} | Cancelled from REGISTERED or | Yes |
| WORK | ACTIVE state before work began | |
| CANCELLED_IN_{—} | Cancelled from ACTIVE state after | Yes |
| PROGRESS | work began | |
| REJECTED | Proposed mandate rejected by the | Yes |
| | performing agent | |

### Transition Rules:

| | |
|---|---|
| TRANSITIONS = { | |
| DRAFT: | [REGISTERED, PROPOSED, CANCELLED_DRAFT], |
| PROPOSED: | [REGISTERED, REJECTED, CANCELLED_DRAFT, PROPOSED], |
| REGISTERED: | [ACTIVE, CANCELLED_PRE_WORK], |
| ACTIVE: | [RECEIPT_ACCEPTED, RECEIPT_INVALID, EXPIRED, |
| | CANCELLED_PRE_WORK, CANCELLED_IN_PROGRESS], |
| RECEIPT_INVALID: | [RECEIPT_ACCEPTED, RECEIPT_INVALID, EXPIRED, |
| | CANCELLED_IN_PROGRESS], |
| RECEIPT_ACCEPTED: | [VERIFYING], |
| VERIFYING: | [VERIFIED_PASS, VERIFIED_FAIL], |
| VERIFIED_PASS: | [FULFILLED, VERIFIED_FAIL], |
| VERIFIED_FAIL: | [REMEDIATED, VERIFIED_PASS], |
| FULFILLED: | [ ], - - Terminal |
| REMEDIATED: | [ ], - - Terminal |
| EXPIRED: | [ ], - - Terminal |
| CANCELLED_DRAFT: | [ ], - - Terminal |
| CANCELLED_PRE_WORK: | [ ], - - Terminal |
| CANCELLED_IN_PROGRESS: | [ ], - - Terminal |
| REJECTED: | [ ], - - Terminal |
| } | |

### State Machine Enforcement:

Every state transition in the system is validated by an assertTransition(fromState, toState) function that checks the transition table. If the transition is not permitted, the system throws an InvalidTransitionError. This function is called at every transition point, including the three intermediate transitions during cascading verification (ACTIVE->RECEIPT_ACCEPTED->VERIFYING->VERIFIED_PASS/FAIL).

The specific state machine described herein is one embodiment; alternative embodiments may use fewer or additional intermediate states while preserving the core sibling-complete aggregation and atomic transition properties.

Transitions within the Cascading Verification Transaction:

During the cascading verification algorithm (Section 5, Step 10), the parent mandate transitions through three states within a single database transaction:
1. ACTIVE->RECEIPT_ACCEPTED (simulating receipt acceptance for the parent based on cascaded results)
2. RECEIPT_ACCEPTED->VERIFYING (entering verification state)
3. VERIFYING->VERIFIED_PASS or VERIFIED_FAIL (recording the aggregate outcome)

Each transition increments the version counter and is validated against the state machine. The three transitions are atomic because they occur within the same database transaction. If any transition fails (e.g., due to an invalid state), the entire transaction is rolled back, leaving the parent in its original ACTIVE state.

### Terminal Verification State Definition:

As used herein, “terminal verification state” refers to a verification state from which no further verification processing occurs, specifically: VERIFIED_PASS, VERIFIED_FAIL, FULFILLED, and REMEDIATED. This is distinct from other terminal lifecycle states (such as EXPIRED, CANCELLED, or REJECTED) which represent administrative endings that do not involve verification outcome determination.

### Terminal State Recognition:

The function isTerminal(status) returns true if and only if the transition table maps the status to an empty set. Terminal states are significant for the sibling-complete check: a sibling is considered “complete” for aggregation purposes only if it is in one of the four verification-terminal states: VERIFIED_PASS, VERIFIED_FAIL, FULFILLED, or REMEDIATED.

### 8. Audit Trail Integration

The audit trail is maintained in an append-only data store (referred to herein as the “audit vault”) that records every state change, verification event, and delegation event for each mandate. The audit vault provides tamper-evident integrity through a cryptographic hash chain and optional digital signatures. The detailed architecture of the audit vault is described in co-pending U.S. Provisional Application No. 63/999,669, which is incorporated by reference herein.

### Audit Vault Record Structure:

Each audit vault entry contains the following fields: -entry_id (UUID, primary key): Unique identifier for the entry. -mandate_id (UUID, NOT NULL): The mandate this entry pertains to. Each mandate has its own independent hash chain. -entry_type (VARCHAR, NOT NULL): The type of event recorded. Cascading verification produces two entry types: CASCADING_VERIFICATION_STARTED and CASCADING_VERIFICATION_COMPLETE. -payload (JSONB, NOT NULL): A structured JSON object containing the full context of the event. For cascading verification, this includes the parent mandate identifier, sub-mandate identifiers and their statuses, and the aggregate outcome. -payload_hash (VARCHAR (64), NOT NULL): A SHA-256 hash of the canonicalized payload (see below). -previous_hash (VARCHAR (64), nullable): The payload_hash of the immediately preceding entry in this mandate's hash chain. NULL for the first entry in the chain. -chain_position (INTEGER, NOT NULL): The one-indexed position of this entry in the mandate's hash chain. The first entry has chain_position=1. -signature (TEXT, nullable): An Ed25519 digital signature covering the chain_position, payload_hash, and previous_hash fields. Present when a signing key is configured. -signing_key_id (VARCHAR, nullable): The fingerprint (truncated SHA-256 of the public key) identifying which signing key produced the signature. -created_at (TIMESTAMPTZ, default NOW( )): Creation timestamp.

### Canonicalization and Hashing:

The payload_hash is computed as follows:
1. The payload JSON object is serialized using the JSON Canonicalization Scheme (JCS) defined in RFC 8785. JCS produces deterministic serialization by: (a) sorting object keys lexicographically by Unicode code point, (b) normalizing number representations (including converting −0 to 0), (c) using standard JSON string escaping, and (d) omitting whitespace between tokens.
2. The canonical JSON string is hashed using SHA-256, producing a 64-character hexadecimal digest.

This two-step process ensures that the same payload always produces the same hash, regardless of the order in which JSON keys are serialized by different programming language implementations.

### Hash Chain Linkage:

Each mandate has an independent, linear hash chain of audit entries. The linkage is formed by the previous_hash field:

| | |
|---|---|
| Entry 1: previous_hash = NULL, | payload_hash = H1 |
| Entry 2: previous_hash = H1, | payload_hash = H2 |
| Entry 3: previous_hash = H2, | payload_hash = H3 |
| . . . | |
| Entry N: previous_hash = H (N-1), | payload_hash = HN |

To verify chain integrity, a verifier reads all entries for a mandate in chain_position order and checks that: (a) each entry's chain_position is sequential starting from 1; (b) each entry's payload_hash matches the SHA-256 of the JCS-canonicalized payload; and (c) each entry's previous_hash matches the payload_hash of the preceding entry (with the first entry's previous_hash being NULL).

### Digital Signatures:

When a signing key is configured (via the VAULT_SIGNING_KEY environment variable), each audit vault entry is additionally signed using Ed25519. The signature input is a deterministic string constructed as:

$$sign\_input = chain\_position + “ : ” + payload\_hash + “ : ” + ( previous\_hash OR “ null ” )$$

For example: 3: a1b2c3d4 . . . : e5f6g7h8 . . .

The signature is computed using the Ed25519 private key and stored as a hexadecimal string. The corresponding public key fingerprint is stored in signing_key_id for key identification.

Signatures provide non-repudiation in addition to the tamper-evidence provided by the hash chain. Even if an attacker with database access were to recompute the hash chain after modifying an entry (updating all subsequent previous_hash values), the Ed25519 signatures on the original entries would not validate against the modified payloads.

### Append-Only Enforcement:

The audit vault is enforced as append-only at the database permission level: the application database user has INSERT and SELECT privileges on the audit vault table, but UPDATE and DELETE privileges are revoked. This provides defense-in-depth against application-level bugs that might attempt to modify historical entries.

### Same-Transaction Atomicity:

Critically for the present invention, audit vault entries are appended within the same database transaction as the state change they record. During cascading verification:
The CASCADING_VERIFICATION_STARTED entry is written within the same transaction that acquires the FOR UPDATE lock on the parent and before the state transitions.
The CASCADING_VERIFICATION_COMPLETE entry is written after the final state transition but before the transaction commits.

This ensures that the audit trail is always consistent with the mandate's state. It is impossible for a state transition to be committed without its corresponding audit entry, or for an audit entry to exist for a state transition that was rolled back.

### Concurrent Audit Chain Integrity:

The getLatestEntry function, which retrieves the most recent audit entry for a mandate to determine the previous_hash and chain_position for a new entry, uses SELECT . . . FOR UPDATE to lock the latest entry row. This prevents two concurrent transactions from reading the same latest entry and computing the same chain_position, which would break the chain's sequential ordering. Within the cascading verification algorithm, this lock is subsumed by the broader transaction lock, but it protects audit chain integrity in other contexts where audit entries may be written concurrently (e.g., when a mandate receives both a verification result and a dispute filing in close temporal proximity).

### 9. Recursive Upward Propagation

The recursive nature of delegation chain verification is achieved through the interaction between the sibling-complete aggregation algorithm (Section 5) and the verification completion signal handler (Section 4). This section describes the full recursive propagation flow through a multi-level delegation chain.

### Propagation Mechanics:

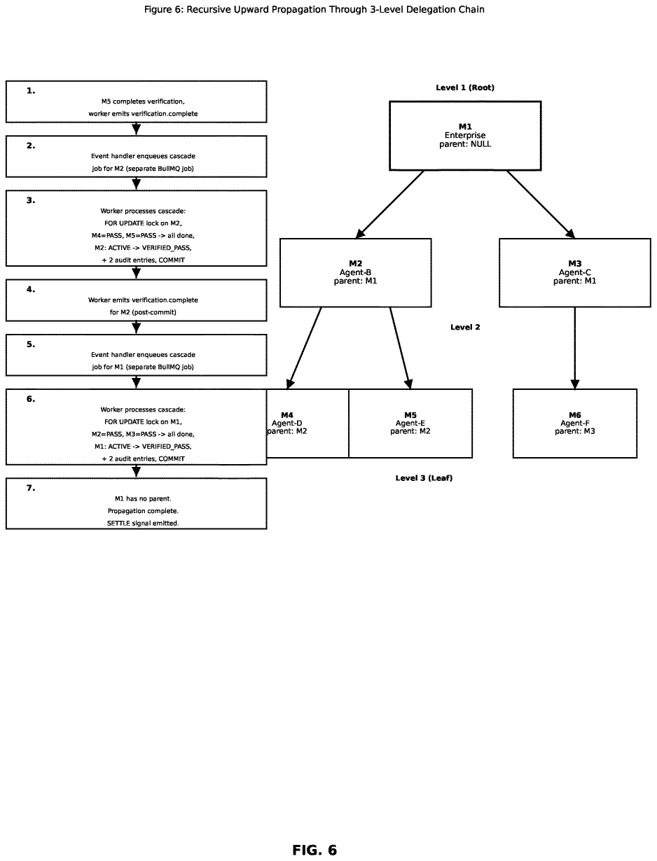

Consider a three-level delegation chain as shown in FIG. 6:

| Root Mandate R (chain_depth=0) | |
|---|---|
| \| | |
| +- - | Sub-Mandate S1 (chain_depth=1, parent=R) |
| \| | \| |
| \| | +- - Leaf Mandate L1 (chain_depth=2, parent=S1) |
| \| | +- - Leaf Mandate L2 (chain_depth=2, parent=S1) |
| \| | |
| +- - | Sub-Mandate S2 (chain_depth=1, parent=R) |

The propagation proceeds as follows:
1. L1 completes verification. The verification worker executes semantic verification on L1's attestation, transitions L1 to VERIFIED_PASS (or VERIFIED_FAIL), and emits a verification.complete event with parentMandateId=S1.
2. Cascading job enqueued for S1. The event handler detects the non-null parentMandateId and enqueues a cascading propagation job: {completedSubMandateId: L1}.
3. Cascading job for S1 executes. The worker acquires a FOR UPDATE lock on S1, queries S1's children (L1 and L2), and checks if both are in terminal states.
   If L2 is not yet in a terminal state, the worker releases the lock and returns. The system will be re-triggered when L2 completes.
   If L2 is in a terminal state (perhaps it completed earlier), the worker computes the aggregate outcome and transitions S1 to VERIFIED_PASS or VERIFIED_FAIL. It then emits a verification.complete event with parentMandateId=R.
4. Cascading job enqueued for R. The event handler detects the non-null parentMandateId and enqueues a cascading propagation job: {completedSubMandateId: S1}.
5. Cascading job for R executes. The worker acquires a FOR UPDATE lock on R, queries R's children (S1 and S2), and checks if both are in terminal states.
   If S2 is not yet in a terminal state, the worker releases the lock and returns.
   If S2 is in a terminal state, the worker computes the aggregate and transitions R to its final state.
6. Propagation terminates. R has parent_mandate_id=NULL, so the verification.complete event emitted for R has no parentMandateId. The event handler does not enqueue another cascading job. Propagation terminates.

### Key Properties of Recursive Propagation:

Property 1: Each propagation level is an independent transaction. The cascading verification at level N commits its transaction and releases its locks before the cascading verification at level N−1 begins. This means that at no point does the system hold locks on multiple levels of the hierarchy simultaneously. Lock duration is bounded by a single sibling-complete aggregation.

Property 2: Propagation is eventually consistent. There is a finite delay between the commitment of a state transition at one level and the beginning of the cascading verification at the next level. This delay includes the time for event emission, queue enqueue, and worker polling. In practice, this delay is on the order of milliseconds to low seconds.

Property 3: Propagation is bounded. The maximum number of cascading propagation steps for a single leaf completion is equal to the maximum chain depth minus one. In the preferred embodiment, the maximum chain depth is 5, so a leaf completion triggers at most 4 cascading propagation steps.

Property 4: Propagation is durable. Because cascading jobs are enqueued to a durable message queue (backed by persistent storage with a noeviction policy), propagation survives process crashes. If a worker process crashes after committing a state transition but before the next cascading job is fully processed, the queue's at-least-once delivery guarantee ensures the job will be retried.

Property 5: Propagation is idempotent. The ACTIVE state check in Step 3 of the algorithm ensures that processing a cascading job for a parent that has already been transitioned has no effect. This, combined with the FOR UPDATE lock, means that duplicate or out-of-order cascading jobs produce the correct result.

### Aggregation Semantics:

The present invention implements a strict “all-pass” aggregation policy: -If all sibling sub-mandates are in a passing terminal state (VERIFIED_PASS or FULFILLED), the parent is transitioned to VERIFIED_PASS. —If any sibling sub-mandate is in a failing terminal state (VERIFIED_FAIL or REMEDIATED), the parent is transitioned to VERIFIED_FAIL.

This semantics reflects the principle that a parent task is only as strong as its weakest sub-task: if any sub-task failed verification, the parent task's overall verification outcome is failure.

### 10. Alternative Embodiments

The following alternative embodiments describe variations of the system and method that fall within the scope of the present invention.

### 10.1 Optimistic Locking Instead of Pessimistic Locking

In an alternative embodiment, the SELECT . . . FOR UPDATE pessimistic lock in Step 2 of the sibling-complete aggregation algorithm is replaced with purely optimistic concurrency control. In this embodiment, the algorithm reads the parent's status and version without acquiring a lock, queries the sibling states, and then attempts to transition the parent using a conditional update:

UPDATE mandate_records
SET status = $new_status, version = version + 1
WHERE id = $parent_id AND version = $expected_version AND status = ‘ACTIVE’
RETURNING *

If the update matches zero rows (because the version or status has changed), the worker retries the entire operation from Step 1. This embodiment eliminates lock contention but introduces the possibility of wasted work (reading sibling states and computing the aggregate only to find the parent has already been processed). The optimistic approach may be preferable in systems where sibling completion events are rarely concurrent, while the pessimistic approach is preferable in systems where concurrent completions are common.

10.2 in-Process Recursive Propagation

In an alternative embodiment, the cascading propagation is performed synchronously within the same process rather than through a durable message queue. After transitioning the parent to a terminal verification state, the algorithm checks whether the parent has a parent_mandate_id and, if so, immediately invokes the sibling-complete aggregation algorithm recursively:

```
FUNCTION checkCascadingVerificationRecursive(pool, completedSubMandateId):
  // . . . Steps 1-12 as in Section 5 . . .
  COMMIT
  // Instead of emitting event + enqueuing job:
  IF parent.parent_mandate_id IS NOT NULL THEN
    checkCascadingVerificationRecursive(pool, parentId) // Recursive call
  END IF
```

This embodiment has lower latency (no queue polling delay) but sacrifices durability: if the process crashes after committing the state transition but before the recursive call completes, propagation to higher levels is lost. This embodiment may be appropriate for systems where process reliability is high and latency is critical, but it is not preferred for systems requiring strong durability guarantees.

### 10.3 Weighted Aggregation

In an alternative embodiment, the “all-pass” aggregation policy is replaced with a weighted or threshold-based aggregation. For example:
Majority-pass threshold: The parent passes if more than a configurable percentage (e.g., 80%) of siblings passed verification.
Weighted aggregation: Each sibling is assigned a weight (stored in the mandate record), and the parent passes if the weighted sum of passing siblings exceeds a threshold.
Critical-sibling policy: Certain siblings are marked as “critical” (e.g., via a flag in the mandate record), and the parent passes only if all critical siblings pass, regardless of non-critical sibling outcomes.

These alternative aggregation policies would be implemented by modifying Steps 5-6 of the sibling-complete aggregation algorithm while preserving the concurrency control, audit trail, and recursive propagation mechanisms.

### 10.4 Event-Sourced State Management

In an alternative embodiment, the mandate's current state is not stored as a mutable field in the relational data store but is instead derived by replaying the sequence of events in the audit vault. In this embodiment:
The status and version fields are removed from the mandate record.
State transitions are recorded as audit vault entries with event payloads describing the transition.
The current state is computed by reading the mandate's audit vault chain and applying each event in order.
The FOR UPDATE lock is acquired on the most recent audit vault entry rather than the mandate record.

This embodiment provides a stronger audit guarantee (the event log is the authoritative state) but introduces read amplification: determining a mandate's current state requires reading and replaying its entire event history. Materialized views or caching layers can mitigate this cost. This embodiment may be preferred in regulatory environments where an immutable event log is required as the system of record.

### 10.5 Merkle Tree Audit Trail

In an alternative embodiment, the linear hash chain described in Section 8 is replaced with a Merkle tree structure. In this embodiment:
Audit vault entries are organized as leaf nodes in a binary Merkle tree.
Each internal node contains the hash of its two children.
The root hash of the tree provides a single digest that commits to the entire audit history.
The tree_position field (already present in the preferred embodiment's data model, though unused) stores the entry's position in the Merkle tree.

The Merkle tree embodiment enables efficient proof-of-inclusion: to prove that a specific audit entry exists in the audit history, only O(log N) hashes need to be provided (the path from the leaf to the root), rather than the entire chain. This is advantageous for systems where individual audit entries must be verified independently without accessing the full chain. However, the Merkle tree introduces complexity in tree rebalancing and position computation during concurrent writes.

### 10.6 Alternative Queue Technologies

In alternative embodiments, the durable message queue may be implemented using other technologies such as Apache Kafka, Amazon SQS, RabbitMQ, or any persistent message queue that provides at-least-once delivery guarantees and configurable retry policies.

### 10.7 Alternative Data Store Technologies

In alternative embodiments, the persistent data store may be implemented using document-oriented databases, distributed databases, or other non-relational data stores that support atomic transactions and row-level or document-level locking. The specific SQL-based query patterns described herein are illustrative; equivalent operations may be performed using the query languages and locking mechanisms native to the chosen data store.

### 11. Settlement Signal Generation and Delivery

When a task specification record reaches a terminal verification state—whether through direct verification of a submitted task attestation or through the hierarchical cascading propagation described in Section 5—the system generates a settlement signal indicating the financial disposition recommended for the task.

### 11.1 Signal Type Determination

The settlement signal type is derived directly from the terminal verification state:
SETTLE: Generated when the terminal verification state is a passing state (VERIFIED_PASS or FULFILLED), indicating that the task was completed satisfactorily and payment should proceed.
HOLD: Generated when the terminal verification state is a failing state (VERIFIED_FAIL or REMEDIATED), indicating that the task completion was deficient and payment should be withheld pending resolution.
RELEASE: Generated when a previously opened dispute is overturned, indicating that a prior HOLD signal should be reversed and payment should proceed.

### 11.2 Signal Structure

The settlement signal comprises the following fields:

SettlementSignal {

| | | |
|---|---|---|
| signalId: | UUID | - - Unique indentifier for this signal instance |
| mandateId: | UUID | - - The task specification record that triggered the signal |
| signalType: | Enum | - - ‘SETTLE’, ‘HOLD’, or ‘RELEASE’ |
| outcome: | Enum | - - ‘PASS’ or ‘FAIL’ |
| contractType: | String | - - The contract type indentifier of the triggering mandate |
| agentId: | UUID | - - The performing agent on the triggering mandate |
| enterpriseId: | UUID? | - - The enterprise associated with the mandate chain |
| chainDepth: | Integer | - - The depth of the triggering mandate in the delegation hierachy |
| rootMandateId: | UUID | - - The root of the delegation chain |
| timestamp: | ISO 8601 | - - When the signal was generated |
| } | | |

### 11.3 Per-Level Signal Generation

Settlement signals are generated at each level of the delegation hierarchy as each task specification record independently reaches a terminal verification state. When a leaf-level mandate completes verification, a settlement signal is generated and transmitted for that mandate. When the sibling-complete aggregation algorithm (Section 5) subsequently transitions the parent mandate to a terminal state, a separate settlement signal is generated for the parent mandate. This per-level generation continues recursively upward through the hierarchy.

This design ensures that settlement signals are available for each level of the delegation hierarchy independently of whether ancestor-level aggregation has completed. A payment platform monitoring a specific sub-task receives a settlement signal as soon as that sub-task is verified, without waiting for the entire delegation tree to complete.

In an alternative embodiment, settlement signals are generated only when the root task specification record of a delegation chain reaches a terminal verification state, producing a single signal per complete delegation tree rather than per-level signals. This root-only approach reduces signal volume but delays settlement notification until the entire hierarchy has been verified.

### 11.4 Webhook Transmission

Settlement signals are transmitted to registered webhook endpoints via HTTPS POST requests. Each organizational entity may register one or more webhook subscription endpoints, each specifying a URL and an event type filter. When a settlement signal is generated, the system identifies all webhook subscriptions associated with the organizational entity that owns the triggering mandate and that include the signal.emitted event type in their filter.

For each matching subscription, the system enqueues a webhook delivery job to a durable message queue. A dedicated webhook delivery worker processes these jobs, performing the following steps:
1. Construct the HTTP request payload containing the settlement signal fields.
2. Compute an HMAC-SHA256 signature over the concatenation of the current Unix timestamp and the raw request body, using a shared secret specific to the webhook subscription.
3. Transmit the HTTP POST request to the registered endpoint URL with the signature in a request header.
4. If the endpoint returns an HTTP 2xx response, mark the delivery as successful.
5. If the endpoint returns an HTTP 5xx response, 408 (Request Timeout), or 429 (Too Many Requests), requeue the delivery for retry with exponential backoff (1 second, 5 seconds, 30 seconds, 5 minutes, 30 minutes, 2 hours).
6. If the endpoint returns any other 4xx response, mark the delivery as permanently failed without retry.

Each delivery includes a unique delivery identifier that enables the receiving endpoint to implement idempotent processing of duplicate deliveries that may occur due to at-least-once delivery semantics.

### 11.5 Confidence Metadata

In an enhanced embodiment, the settlement signal generated when a task specification record reaches a terminal verification state through hierarchical propagation includes confidence metadata comprising:
Passing ratio: The ratio of child task specification records that achieved passing verification states (VERIFIED_PASS or FULFILLED) to the total number of child task specification records in the immediate parent-child relationship. For example, if a parent mandate has three child mandates and two achieved passing states, the passing ratio is 2/3.
Hierarchy depth: The chain depth of the triggering task specification record, indicating how many levels of delegation exist between the triggering mandate and the root mandate.
Total descendants: The total number of task specification records in the subtree rooted at the triggering mandate.

This confidence metadata provides downstream payment platforms and decision systems with additional context about the degree of consensus in the verification hierarchy, enabling risk-proportionate settlement decisions. The confidence metadata is recorded in the cryptographically hash-chained audit entry associated with the settlement signal generation event.

### 12. Encrypted Envelope Mode

In certain deployment scenarios, the content of task attestation evidence may be confidential and must not be exposed to the verification system's server-side processes. The system supports an encrypted envelope mode that enables hierarchical verification propagation without requiring the system to inspect attestation content.

### 12.1 Operating Mode Declaration

Each task specification record may declare an operating mode of either cleartext (default) or encrypted. The operating mode is specified at mandate creation time and is immutable for the lifetime of the task specification record. When a mandate is created as a child in a delegation chain, its operating mode is independent of its parent's mode.

### 12.2 Encrypted Envelope Structure

When a task attestation is submitted for a task specification record in encrypted mode, the attestation evidence must be enclosed in an encrypted envelope conforming to AES-256-GCM authenticated encryption. The envelope comprises the following fields:

EncryptedEnvelope {

| | | |
|---|---|---|
| v: | Integer | - - Envelope format version (currently 1) |
| alg: | String | - - Encryption algorithm identifier (must be “AES-256-GCM”) |
| enc: | String | - - Base64-encoded ciphertext containing the encrypted attestation evidence |
| iv: | String | - - Base64-encoded intialization vector (96 bits for AES-256-GCM) |
| tag: | String | - - Base64-encoded authentication tag (128 bits for AES-256-GCm) |
| } | | |

12.3 Structural Validation without Decryption

The system performs structural validation of the encrypted envelope without decrypting the ciphertext. This validation comprises:
1. Verifying that all required envelope fields (v, alg, enc, iv, tag) are present.
2. Verifying that the alg field contains the value “AES-256-GCM”.
3. Verifying that the enc, iv, and tag fields are valid Base64-encoded strings.
4. Verifying that the submitter has also provided an evidenceHash field containing a SHA-256 digest, since the server cannot compute a hash of the unencrypted evidence.

The server-side two-phase verification process (structural and semantic) described in the related provisional application (No. 63/999,674) is skipped for encrypted-mode mandates, as the server cannot inspect the attestation content.

### 12.4 Principal-Reported Outcome

For encrypted-mode task specification records, verification outcome is determined by a principal-reported outcome mechanism. The principal (the entity that created the task specification record) submits an outcome declaration indicating whether the encrypted attestation evidence satisfies the mandate's acceptance criteria. The principal-reported outcome has the same structure as a server-verified outcome (PASS or FAIL) and is recorded in the append-only audit store with a reporter type identifier indicating that the outcome was principal-reported rather than server-verified.

The principal-reported outcome triggers the same downstream effects as a server-verified outcome: the mandate transitions through the state machine to a terminal verification state, an audit vault entry is appended, and if the mandate is a sub-mandate in a delegation chain, a deferred propagation job is enqueued to trigger the sibling-complete aggregation algorithm described in Section 5. The hierarchical propagation mechanism operates identically regardless of whether the terminal verification state was reached through server-side verification or principal-reported outcome.

### 13. Cross-Organizational Delegation and Proposal Workflow

### 13.1 Cross-Organizational Hierarchies

The bounded-depth tree-structured hierarchy supports delegation across organizational boundaries. Each task specification record is associated with an organizational identifier (e.g., enterprise_id). When a computational entity within one organization delegates a sub-task to a computational entity within a different organization, the child task specification record is associated with the second organization's identifier while maintaining the parent-child relationship via parent_mandate_id.

The hierarchical verification propagation mechanism operates transparently across organizational boundaries: the sibling-complete aggregation algorithm (Section 5) evaluates terminal verification states of all sibling task specification records sharing the same parent identifier regardless of which organizational entity owns each sibling. The row-level exclusion lock, atomic state transition, audit vault append, and deferred propagation steps proceed identically whether the parent and child mandates belong to the same organization or different organizations.

The root_mandate_id field maintains lineage back to the originating task specification record, and the enterprise_id field is inherited from the parent mandate during delegation when not explicitly overridden, ensuring organizational lineage is preserved through the chain even when intermediate levels involve different organizations.

### 13.2 Proposal Workflow

Prior to a task specification record being activated in the delegation hierarchy, the system supports a proposal lifecycle that establishes mutual agreement between the delegating entity (principal) and the performing entity (performer). The proposal workflow comprises the following stages:
1. Proposal Creation: The principal creates a task specification record in a PROPOSED state, specifying acceptance criteria, tolerance bands, a deadline, and the intended performer. The task specification record is not yet part of the active verification hierarchy.
2. Performer Response: The intended performer may respond with one of three actions:
   Accept: The performer accepts the proposed terms. The task specification record transitions from PROPOSED to ACTIVE, and it becomes eligible for receipt submission, verification, and hierarchical propagation.
   Reject: The performer rejects the proposed terms. The task specification record transitions to a rejected terminal state and is not activated.
   Counter-Proposal: The performer responds with modified terms (e.g., different acceptance criteria, adjusted tolerance bands, or an extended deadline). The task specification record remains in a proposed state with the modified terms recorded.
3. Counter-Proposal Resolution: If the performer submitted a counter-proposal, the principal may accept the modified terms (transitioning the mandate to ACTIVE with the counter-proposed terms) or reject them.

Each transition in the proposal lifecycle is recorded in the append-only audit store, creating a cryptographically hash-chained record of the negotiation history. The proposal lifecycle state transitions are separate from and precede the verification state machine transitions described in Section 7.

### 13.3 Tolerance Band Specification and Evaluation

Each task specification record's acceptance criteria may include configurable tolerance bands that define permitted deviation ranges for numeric criteria fields. Tolerance bands are specified in the tolerance field of the task specification record as a structured JSON object with the following supported parameters:
quantity_pct: Percentage tolerance on quantity fields (e.g., 5.0 means±5%).
price_margin: Absolute tolerance on price fields in the denomination currency.
price_margin_pct: Percentage tolerance on price fields.
grace_seconds: Time tolerance on deadline-related fields, in seconds.
budget_margin: Absolute tolerance on budget fields in the denomination currency.

During verification of a submitted task attestation, the system evaluates each numeric criteria field against the corresponding acceptance criteria value, applying the applicable tolerance band. A criteria field achieves a passing determination when the deviation between the attested value and the acceptance criteria value falls within the range defined by the corresponding tolerance parameter. A task specification record achieves a passing terminal verification state (VERIFIED_PASS) when all evaluated criteria fields achieve passing determinations under their respective tolerance bands.

The tolerance band evaluation feeds directly into the hierarchical propagation mechanism: the terminal verification state resulting from tolerance-aware criteria evaluation determines whether the task specification record is classified as passing or failing in the sibling-complete aggregation at the parent level (Section 5, Steps 5-6).

What is claimed is:

1. A system for maintaining data integrity during hierarchical task verification in a distributed computing environment, comprising: a persistent data store storing a plurality of task specification records organized in a bounded-depth tree-structured hierarchy, each task specification record having at most one parent task specification record identifier referencing another task specification record, such that the task specification records form a forest of rooted trees with a configured maximum delegation depth; a durable message queue providing at-least-once delivery of asynchronous processing jobs; one or more processors coupled to the persistent data store and the durable message queue, configured to, upon receiving a deferred propagation job from the durable message queue indicating that a child task specification record has reached a terminal verification state: (a) identify the parent task specification record referenced by the child task specification record's parent identifier; (b) acquire a row-level exclusion lock on the parent task specification record in the persistent data store within a database transaction; (c) query all sibling task specification records sharing the same parent identifier; (d) determine whether all sibling task specification records have reached terminal verification states, the terminal verification states comprising VERIFIED_PASS, VERIFIED_FAIL, FULFILLED, and REMEDIATED; (e) if all sibling task specification records are in terminal verification states, compute an aggregate verification outcome based on the terminal verification states of all siblings, wherein the aggregate outcome is a passing outcome if and only if all siblings are in passing terminal states, the passing terminal states being VERIFIED_PASS and FULFILLED; (f) atomically transition the parent task specification record through a series of intermediate states in a defined state machine to a terminal verification state corresponding to the aggregate outcome, each transition incrementing a version counter; (g) append a cryptographically hash-chained audit entry to an append-only audit store within the same database transaction as step (f), the audit entry comprising a cryptographic hash of a canonicalized payload and a reference to the preceding entry's hash in the same task specification record's chain; (h) if the parent task specification record itself references a further parent identifier, enqueue a deferred propagation job to a durable message queue for the further parent task specification record, the deferred propagation job causing a separate worker process to perform steps (a) through (g) for the further parent task specification record in a separate database transaction, up to a configured maximum delegation depth.

2. A computer-implemented method for propagating verification outcomes through a hierarchical delegation chain of task specification records in a distributed computing environment, comprising: receiving, by one or more processors from a durable message queue, a deferred propagation job indicating that a child task specification record has reached a terminal verification state; within a single database transaction: acquiring a row-level exclusion lock on a parent task specification record referenced by the child task specification record's parent identifier; querying all sibling task specification records sharing the same parent identifier; determining whether all sibling task specification records have reached terminal verification states; if all siblings are in terminal verification states, computing an aggregate verification outcome and atomically transitioning the parent task specification record through intermediate states in a defined state machine to a terminal verification state corresponding to the aggregate outcome; appending a cryptographically hash-chained audit entry to an append-only audit store within the same database transaction; committing the database transaction; wherein the database transaction holding the row-level exclusion lock is bounded to a single parent-sibling aggregation and does not hold locks on ancestor task specification records; after committing the database transaction, if the parent task specification record itself references a further parent identifier, enqueuing a deferred propagation job to the durable message queue for the further parent task specification record, thereby deferring ancestor-level propagation to a separate database transaction.

3. A non-transitory computer-readable storage medium storing instructions that, when executed by one or more processors coupled to a persistent data store and a durable message queue, cause the processors to perform operations comprising the steps of the method of claim 2.

4. The system of claim 1, wherein creating a delegation relationship further comprises executing a recursive common table expression query against the persistent data store that walks the delegation chain from the proposed parent task specification record to the root task specification record, checking at each level whether the proposed performing agent identifier matches any existing performing agent identifier or principal agent identifier in the chain, and rejecting the delegation if a match is found, thereby preventing circular delegation chains.

5. The system of claim 4, wherein the recursive common table expression query is executed as a single database round-trip that terminates in at most N iterations, where N is the configured maximum delegation chain depth.

6. The system of claim 1, wherein in an alternative concurrency mode, the row-level exclusion lock in step (b) is replaced with a SKIP LOCKED clause that causes a concurrent worker to skip the locked parent task specification record and defers propagation to a retry queue for subsequent processing.

7. The system of claim 1, wherein the series of intermediate states in step (f) comprises transitioning the parent task specification record from an ACTIVE state to a RECEIPT_ACCEPTED state, from the RECEIPT_ACCEPTED state to a VERIFYING state, and from the VERIFYING state to either a VERIFIED_PASS state or a VERIFIED_FAIL state, each transition validated against a state machine transition table and each transition incrementing the version counter.

8. The system of claim 1, wherein the configured maximum delegation depth is a runtime-configurable parameter, and wherein the chain depth is computed at delegation creation time as the parent task specification record's chain depth plus one and stored in the child task specification record.

9. The system of claim 1, wherein the deferred propagation job in step (h) is enqueued only after the database transaction in steps (b) through (g) has been committed, ensuring that the parent task specification record's terminal verification state is visible in the persistent data store before the next ancestor-level propagation job executes.

10. The system of claim 7, wherein if all sibling task specification records are in passing terminal verification states and the parent task specification record has a configured commission percentage parameter, the system atomically computes a derived commission value from numeric cost fields within the sibling task specification records' acceptance criteria and persists the computed commission value in the parent task specification record within the same database transaction as the state transitions, thereby ensuring transactional atomicity between the verification state change and the commission computation.

11. The system of claim 1, wherein each state transition in step (f) further comprises a conditional update that matches the current version counter value stored in the persistent data store, such that if the version counter has been incremented by a concurrent transaction since the row-level exclusion lock was acquired, the state transition is rejected, providing a secondary concurrency control mechanism independent of the row-level exclusion lock.

12. The system of claim 1, wherein processing a deferred propagation job for a parent task specification record that has already been transitioned to a terminal verification state results in no state modification to the parent task specification record, providing idempotent propagation processing that tolerates duplicate or replayed propagation jobs.

13. The method of claim 2, wherein the deferred propagation job is enqueued with a deduplication identifier derived from the completed child task specification record's identifier, such that the durable message queue prevents duplicate propagation jobs for the same child task specification record completion event from being processed concurrently.

14. The system of claim 1, wherein each task specification record maintains an independent cryptographic hash chain in the append-only audit store, such that appending an audit record for one task specification record does not affect the chain integrity verification of any other task specification record's audit chain.

15. The system of claim 1, wherein when a task specification record in the hierarchy reaches a terminal verification state through hierarchical propagation, the one or more processors further generate a settlement signal comprising a signal type of SETTLE when the terminal verification state is a passing state and a signal type of HOLD when the terminal verification state is a failing state, and transmit the settlement signal to one or more registered webhook endpoints associated with the task specification record.

16. The system of claim 1, wherein the task specification records at different levels of the bounded-depth tree-structured hierarchy are associated with different organizational identifiers, such that a parent task specification record is associated with a first organizational identifier and a child task specification record delegated therefrom is associated with a second organizational identifier different from the first, enabling cross-organizational hierarchical verification propagation wherein the aggregate verification outcome computed at each level reflects task completion across organizational boundaries.

17. The system of claim 1, wherein prior to a task specification record being transitioned to an active state, the system supports a proposal lifecycle wherein a first computational entity transmits proposed task terms comprising acceptance criteria and tolerance parameters to a second computational entity, the second computational entity responds with one of an acceptance, a rejection, or a counter-proposal comprising modified task terms, and the task specification record is transitioned to the active state only upon mutual agreement between the first computational entity and the second computational entity, the proposal lifecycle state transitions being recorded in the append-only audit store.

18. The method of claim 2, further comprising: receiving task attestation evidence for a child task specification record in an encrypted envelope comprising a ciphertext field, an initialization vector field, and an authentication tag field; validating the structural integrity of the encrypted envelope without decrypting the ciphertext contents; and determining the verification outcome for the child task specification record based on a principal-reported outcome rather than server-side content inspection, wherein the principal-reported outcome is recorded in the append-only audit store and propagated through the hierarchical delegation chain in the same manner as server-verified outcomes.

19. The system of claim 1, wherein the acceptance criteria of each task specification record include configurable tolerance bands specifying permitted deviation ranges for numeric criteria fields, and wherein the aggregate verification outcome computation in step (e) incorporates tolerance band evaluation such that a sibling task specification record achieves a passing terminal verification state when deviations between attested values and acceptance criteria values fall within the permitted deviation ranges specified by the corresponding tolerance bands.

20. The system of claim 15, wherein the settlement signal generated upon the root task specification record reaching a terminal verification state through hierarchical propagation further comprises confidence metadata including a ratio of child task specification records that achieved passing verification states to the total number of child task specification records in the hierarchy, and the delegation chain depth of the root task specification record's hierarchy, the confidence metadata being included in the cryptographically signed settlement signal transmitted to the registered webhook endpoints.

21. The system of claim 1, wherein the bounded-depth tree-structured hierarchy of task specification records is constructed dynamically at runtime through delegation operations initiated by computational entities including autonomous software agents, enterprise systems, robotic systems, or human-supervised computational agents, wherein each delegation operation creates a new child task specification record linked to an existing parent task specification record, and the hierarchy topology is not predetermined prior to system execution, such that the number, depth, and branching factor of the hierarchy are determined by delegation decisions made by the computational entities during operation.

22. The system of claim 1, wherein the terminal verification states are determined by evaluating submitted task attestation evidence against acceptance criteria stored in the task specification record, the evaluation comprising comparing attestation evidence field values against corresponding acceptance criteria field values to produce per-field pass or fail determinations, and the aggregate verification outcome reflects whether the attestation evidence satisfies the acceptance criteria rather than whether an associated task execution process completed without error.

23. The system of claim 1, wherein propagation of verification outcomes flows exclusively from child task specification records toward the root task specification record through the tree-structured hierarchy, opposite to the direction in which delegation relationships were created, and the system neither propagates verification outcomes laterally between sibling task specification records nor downward from parent task specification records to child task specification records, and propagation at each level is triggered only upon a sibling-complete condition in which every sibling task specification record sharing the same parent identifier has independently reached a terminal verification state.

24. The system of claim 15, wherein the settlement signal is generated at each level of the hierarchy as each task specification record reaches a terminal verification state through hierarchical propagation, such that intermediate task specification records between the leaf level and the root level each generate and transmit a settlement signal to their respective registered webhook endpoints, enabling per-level settlement notification independently of whether ancestor task specification records have completed their own sibling-complete aggregation.

25. The system of claim 1, wherein each state transition in the defined state machine further records a transition reason identifier and a transition actor identifier within the task specification record, the transition reason identifier indicating the cause of the transition and the transition actor identifier indicating the computational entity or system process that triggered the transition, and wherein the transition reason identifier and transition actor identifier are included in the cryptographically hash-chained audit entry appended during step (g).

26. The system of claim 1, wherein acceptance criteria stored in each task specification record are validated against a contract type schema at task specification record creation time, the validation comprising comparing the structure of the acceptance criteria against a predefined JSON Schema associated with the task specification record's contract type identifier, and rejecting the task specification record creation if the acceptance criteria do not conform to the contract type schema, thereby ensuring that only structurally valid acceptance criteria enter the delegation hierarchy.

27. The method of claim 2, further comprising, prior to creating a delegation relationship between a parent task specification record and a proposed child task specification record: executing a recursive query against the persistent data store that traverses the delegation chain from the parent task specification record to the root task specification record; at each level of the traversal, comparing a proposed performing entity identifier against existing performing entity identifiers and principal entity identifiers in the chain; and rejecting the delegation if a match is found at any level, thereby preventing circular delegation chains within the bounded-depth hierarchy.

28. The method of claim 2, further comprising: upon the parent task specification record reaching a terminal verification state, generating a settlement signal comprising a signal type of SETTLE when the terminal verification state is a passing state and a signal type of HOLD when the terminal verification state is a failing state; computing an HMAC signature over the settlement signal payload using a shared secret associated with a registered webhook subscription; and transmitting the signed settlement signal to one or more registered webhook endpoints, the settlement signal including a unique delivery identifier enabling idempotent processing by the receiving endpoint.

29. The method of claim 2, wherein determining whether a sibling task specification record has reached a passing terminal verification state comprises evaluating deviations between attested values in submitted task attestation evidence and corresponding acceptance criteria values in the sibling task specification record against configurable tolerance band parameters, the sibling task specification record achieving a passing terminal verification state when all evaluated deviations fall within the permitted ranges defined by the tolerance band parameters.

30. The system of claim 1, wherein the aggregate verification outcome computation in step (e) is governed by a configurable aggregation policy associated with the parent task specification record, the aggregation policy being one of: a unanimous policy requiring all sibling task specification records to be in passing terminal states for a passing aggregate outcome; a majority policy requiring more than half of the sibling task specification records to be in passing terminal states; or a weighted policy assigning numeric weights to individual sibling task specification records and requiring the sum of weights of passing siblings to exceed a configured threshold, the aggregation policy being evaluated within the same database transaction as the row-level exclusion lock.
